(19) United States
(12) Patent Application Publication
(10) Pub. No.: US 2026/0369680 A1
(43) Pub. Date: Nov. 19, 2026

(54) ELECTROLYTE AND ITS USE IN LITHIUM-BASED BATTERY

(71) Applicant: City University of Hong Kong, Kowloon (HK)

(72) Inventors: Jijian Xu, Kowloon (HK); Hao Zhang, Kowloon (HK)

(21) Appl. No.: 19/326,149

(22) Filed: Sep. 11, 2025

Related U.S. Application Data
(60) Provisional application No. 63/806,866, filed on May 16, 2025.

(51) Int. Cl. H01M 10/0568; H01M 10/0525; H01M 10/0567; H01M 10/0569

(52) U.S. Cl. CPC H01M 10/0568; H01M 10/0525; H01M 10/0567; H01M 10/0569; H01M 2300/0042

(57) ABSTRACT

An electrolyte for lithium-based battery including at least three lithium salts and a carbonate solvent mixture, wherein the at least three lithium salts are selected from the group consisting of lithium tetrafluoroborate (LiBF₄), lithium difluorooxalate borate (LiDFOB), lithium difluorodioxalate phosphate (LiDFBP), lithium bisfluorosulfonimide (LiFSI) and lithium bis((trifluoromethyl)sulfonyl)azanide (LiTFSI). A lithium-based battery including the electrolyte is also addressed.

### TECHNICAL FIELD

The present invention relates to an electrolyte, for example, particularly, but not exclusively, an electrolyte for lithium-based battery and use of said electrolyte in said lithium-based battery.

### BACKGROUND OF THE INVENTION

The rapid expansion of consumer electronics and electric vehicles has driven an unprecedented demand for lithium-ion batteries (LIBs) that deliver high energy density and reliable performance across extreme temperatures—mitigating range anxiety in long-distance EVs and unlocking applications from the frigid plains of northeastern China and the depths of the ocean to the vacuum of space.

Conventional LIBs, however, relies on ethylene carbonate (EC)-based electrolytes and lithium hexafluorophosphate (LiPF₆), which generally exhibit poor performance under harsh conditions. For example, at low temperatures, EC's high viscosity and de-solvation energy hinder ion transport, thus limiting the low-temperature LIB performance. Particularly, the capacity retention of conventional LIBs below 0°C often drops to less than 25% of its room temperature capacity. At elevated temperatures (≥45 °C), LiPF₆ tends to undergo thermal decomposition. This leads to the generation of corrosive byproducts, such as phosphorus pentafluoride (PF₅) and hydrogen fluoride (HF), subsequently triggering solvent decomposition and structural degradation of electrode materials. Moreover, the inefficient cathode-electrolyte interphase (CEI) formed by traditional carbonate-based electrolytes exacerbates the irreversible phase transition of the cathode material at high voltages (e.g., 4.6 V). These issues hinder the overall energy density and lifespan of LIBs.

The invention thus seeks to eliminate or at least to mitigate such shortcomings by providing a new or otherwise improved electrolyte for lithium-based batteries, particularly lithium-ion batteries.

### SUMMARY OF THE INVENTION

In a first aspect of the present invention, there is provided an electrolyte for lithium-based battery comprising at least three lithium salts and a carbonate solvent mixture, wherein the at least three lithium salts are selected from the group consisting of lithium tetrafluoroborate (LiBF₄), lithium difluorooxalate borate (LiDFOB), lithium difluorodioxalate phosphate (LiDFBP), lithium bisfluorosulfonimide (LiFSI) and lithium bis((trifluoromethyl)sulfonyl)azanide (LiTFSI).

Optionally, the at least three lithium salts include lithium tetrafluoroborate (LiBF₄), lithium difluorooxalate borate (LiDFOB), and lithium difluorodioxalate phosphate (LiDFBP).

It is optional that the lithium tetrafluoroborate (LiBF₄), lithium difluorooxalate borate (LiDFOB), lithium difluorodioxalate phosphate (LiDFBP) have a molar ratio 4:4:3.

Optionally, the at least three lithium salts have a total concentration from about 0.5 M to about 1.5 M.

It is optional that the at least three lithium salts have a total concentration of about 1.1 M.

Optionally, the carbonate solvent mixture includes propylene carbonate (PC), ethyl methyl carbonate (EMC), dimethyl carbonate (DMC), and fluoroethylene carbonate (FEC).

It is optional that the propylene carbonate (PC), ethyl methyl carbonate (EMC), dimethyl carbonate (DMC), and fluoroethylene carbonate (FEC) have a volume ratio of a:b:c:d, where a is about 2-5, b is about 3-5, c is about 1-3, d is about 1-2, with a+b+c+d=1.

Optionally, the electrolyte further comprises an additive selected from the group consisting of vinylene carbonate (VC), 1,3-propanesultone (PS), difluorocarbonated ethylene carbonate (DFEC), tri-(tri-methyl-silane) borate (TMSB), methylene methanedisulfonate (MMDS), and tri-(tri-methyl-silane) phosphate (TMSP), and a combination thereof.

It is optional that mass of the additive is 5% or less of the total mass of the electrolyte.

Optionally, decomposition voltage of the electrolyte is about 4.43 V (vs. Li/Li⁺) under a measurement of linear sweep voltammetry (LSV) with a cutoff current density of about 4 μA cm⁻².

In an optional embodiment, the electrolyte maintains liquid form under a temperature from about −80 °C to about 45 °C

Optionally, the electrolyte is stable below or at about 80 °C for at least 140 hours.

In a second aspect of the present invention, there is provided a lithium-based battery comprising: a cathode comprising a cathode active material selected from the group consisting of lithium cobalt oxide (LCO), lithium iron phosphate (LFP), lithium manganate (LMO), lithium iron phosphate with manganese added (LMFP), nickel-rich NCM, nickel-rich NCA, and graphite; an anode; and an electrolyte comprising at least three lithium salts selected from lithium tetrafluoroborate (LiBF₄), lithium difluorooxalate borate (LiDFOB), and lithium difluorodioxalate phosphate (LiDFBP), and a carbonate solvent mixture selected from the group consisting of propylene carbonate (PC), ethyl methyl carbonate (EMC), dimethyl carbonate (DMC), and fluoroethylene carbonate (FEC).

In an optional embodiment, the cathode comprises a cathode active material of LCO and the anode comprises an anode active material selected from the group consisting of graphite, silicon, lithium metal, silicon-carbon composite, and silicon dioxide.

Optionally, the cathode comprises a cathode active material of graphite and the anode has an anode active material selected from the group consisting of lithium metal, silicon, silicon-carbon composite, and silicon dioxide.

It is optional that the cathode has a mass loading of about 6.6 mg cm⁻².

Optionally, the anode has a mass loading of about 2.0 mg cm⁻² to about 4.0 mg cm⁻².

In an optional embodiment, the lithium-based battery has an average Coulombic efficiency of at least 99% when operated at a voltage of at least 4.6 V under a temperature of about 45 °C

Optionally, the electrolyte is arranged to form a cathode-electrolyte interphase (CEI) on the cathode at a voltage of about 4.6V for stabilizing interfacial phase of said cathode under said high voltage.

It is optional that the cathode-electrolyte interphase is uniformly disposed on the cathode surface and has a thickness from about 7 nm to about 20 nm.

Optionally, the cathode-electrolyte interphase comprises LiF in a concentration gradient such that the LiF concentration is higher at a side proximal to the cathode surface than at a side distal from the cathode surface.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1 is a schematic diagram illustrating the synergistic cation-anion solvation engineering strategy for the tailored electrolytes, enabling superior performance across a wide temperature range and at high voltages, by controlling solvent-salt interactions and promoting a protective, anion-induced CEI;

FIG. 2 shows the binding energies of different carbonate solvents with Li⁺;

FIG. 3A shows the calculated Li⁺-solvent binding energies based on the basis set of B3LYP/6−311++G(d,p);

FIG. 3B shows the calculated Li⁺-solvent binding energies based on the basis set of B3LYP/DGDZVPS;

FIG. 3C shows the calculated Li⁺-solvent binding energies based on the basis set of M062X/6−311++G(d,p);

FIG. 4 shows the minimum and maximum electrostatic potential (ESPₘᵢₙ and ESPₘₐₓ) energies of the solvents;

FIG. 5 shows the comparison of the physicochemical properties of different carbonate solvents;

FIG. 6 shows the freezing point and boiling point of different carbonate solvents;

FIG. 7 is a table summarizing the key physical properties of different carbonate solvents;

FIG. 8 is a table summarizing the comparison between the physical and chemical properties of different solvents. ε refers to dielectric constant; η refers to viscosity; FE refers to freezing point; Li-solvent refers to Li⁺-solvent binding energy; HOMO refers to the HOMO energies of Li⁺-solvent;

FIG. 9 shows the HOMO energies of the components in the designed electrolyte system;

FIG. 10 shows radial distribution functions (RDF) and corresponding coordination numbers for the baseline electrolyte;

FIG. 11 shows radial distribution functions (RDF) and corresponding coordination numbers for the designed electrolyte;

FIG. 12 shows the binding energies between Li⁺ and different anions. The basis set is B3LYP/6−311++G(d, p) with DMSO implicit solvent for single-point energy calculation;

FIG. 13 shows the ⁷Li NMR spectra of different electrolytes;

FIG. 14 shows LSV curves of the baseline electrolyte and designed electrolytes;

FIG. 15 shows the de-solvation energies of Li⁺ in different solvation structures;

FIG. 16 shows the ¹⁹F NMR spectra of baseline electrolyte before and after 144 hours of storage under 80 °C;

FIG. 17 shows the ¹H NMR spectra of the baseline electrolyte before and after 144 hours of storage under 80 °C;

FIG. 18 shows the ¹⁹F NMR spectra (left) and ¹H NMR spectra (right) of designed electrolyte before and after 144 hours of storage under 80 °C;

FIG. 19 shows the DSC profiles of the baseline and designed electrolytes from 30 °C to −85 °C;

FIG. 20 shows the optical images of the baseline electrolyte and designed electrolyte under different temperatures, in which 1 and 2 refer to the baseline electrolyte and designed electrolyte, respectively;

FIG. 21 shows the temperature-dependent ionic conductivities of baseline and designed electrolytes;

FIG. 22 shows the long-term cycling performance of Li||LCO half-cells at 25 °C (2.7-4.6 V vs. Li/Li⁺);

FIG. 23 shows the cycling performance of different Li||LCO half-cells using different batches of electrolyte;

FIG. 24 shows the charging and discharging profiles of the Li||LCO half-cells using baseline electrolyte (left) and designed electrolyte (right) at 25 °C;

FIG. 25A shows the charge/discharge profiles and CE of the activation cycles for Li||LCO half-cells using baseline electrolyte;

FIG. 25B shows the charge/discharge profiles and CE of the activation cycles for Li||LCO half-cells using designed electrolyte;

FIG. 25C shows the CE during long-term cycling of Li||LCO half-cells using different electrolytes and the calculated average CE after 200 cycles. The average CE of designed electrolyte after 400 cycles is 99.45%;

FIG. 26 shows the cycling performance of Li||LCO half-cells at 45 °C;

FIG. 27A shows the charging and discharging profiles of the Li||LCO half-cells using baseline electrolyte (left) and designed electrolyte (right) at 45 °C;

FIG. 27B shows the mean voltage upon discharging of the Li||LCO half-cells using different electrolytes at 45 °C;

FIG. 27C shows the Coulombic efficiency of the Li||LCO half-cells using different electrolytes at 45 °C;

FIG. 28 shows the capacity retention of Li||LCO half-cells under different temperatures at 0.33 C;

FIG. 29 shows the discharge capacity exhibition of Li||LCO half-cell using designed electrolyte under −60 °C at 0.05 C after charged under 25 °C;

FIG. 30 shows the charge/discharge profiles of the Li||LCO half-cells using baseline electrolyte (left) and designed electrolyte (right) at different temperatures;

FIG. 31 shows the over-potential of the Li||LCO half-cells using different electrolytes at different temperatures;

FIG. 32 shows the electrochemical performance of Li||graphite half-cells;

FIG. 33 shows the long-term cycling of the Li||graphite half-cells using different electrolytes at 25 °C (left) and 45 °C (right);

FIG. 34 shows the capacity retention (left) and over-potential (right) of the Li||graphite half-cells using different electrolytes at different temperatures;

FIG. 35 shows the cycling performance of graphite||LCO full-cells using different batches of electrolyte;

FIG. 36A shows the charge/discharge profiles of the graphite||LCO full-cells using baseline electrolyte;

FIG. 36B shows the charge/discharge profiles of the graphite||LCO full-cells using designed electrolyte;

FIG. 37 is a table summarizing the corresponding cell parameters and calculated energy density of assembled graphite (Gr)||LCO full-cells;

FIG. 38A shows the FTIR spectra of EMC solvent, EMC solution with different lithium salts and the designed electrolyte;

FIG. 38B shows the FTIR of EMC solvent and the EMC solution with 20 wt. % LiBF₄;

FIG. 38C shows the FTIR of EMC solvent and the EMC solution with 20 wt. % LiDFBP;

FIG. 38D shows the FTIR of EMC solvent and the EMC solution with 20 wt. % LiDFOB;

FIG. 39 shows the in-situ FTIR spectra of the designed electrolyte during the first cycle;

FIG. 40 shows SEM images of the LCO after 2 activation cycles with a current density at 0.2 C (1 C=200 mAh g⁻¹) using different electrolytes;

FIG. 41 shows the TEM images of LCO particles after 50 cycles with different electrolytes;

FIG. 42A shows the atomic percentages of different elements on LCO surface after 50 cycles in baseline electrolyte with different etching times. The insert shows the atomic percentages of P and Co in line chart format;

FIG. 42B shows the atomic percentages of different elements on LCO surface after 50 cycles in designed electrolyte with different etching times. The insert shows the atomic percentages of P and Co in line chart format;

FIG. 43 shows the F 1s spectra of LCO surface after 50 cycles in baseline electrolyte;

FIG. 44 shows the percentages of the fitted areas for different components based on F 1s XPS spectra with 0, 30, 60 and 90 seconds etching on the LCO surface after 50 cycles in the baseline electrolyte;

FIG. 45 shows the F 1s spectra of LCO surface after 50 cycles in designed electrolyte;

FIG. 46 shows the percentages of the fitted areas for different components based on F 1s XPS spectra with 0, 30, 60 and 90 seconds etching on the LCO surface after 50 cycles in the designed electrolyte;

FIG. 47 shows the B 1s (left) and P 1s (right) XPS core spectra of the LCO after 50 cycles upon different etching times;

FIG. 48 shows the O 1s spectra of LCO surface after 50 cycles in baseline electrolyte;
FIG. 49 shows the percentages of the fitted areas for different components based on O 1s XPS spectra with 0, 30, 60 and 90 seconds etching on the LCO surface after 50 cycles in the baseline electrolyte;
FIG. 50 shows the O 1s spectra of LCO surface after 50 cycles in designed electrolyte;
FIG. 51 shows the percentages of the fitted areas for different components based on O 1s XPS spectra with 0, 30, 60 and 90 seconds etching on the LCO surface after 50 cycles in the designed electrolyte;
FIG. 52A shows the C 1s spectra of LCO surface after 50 cycles in baseline electrolyte (left) and designed electrolyte (right) with different etching times;
FIG. 52B shows the concentration of Li₂CO₃ for the LCO surface after 50 cycles in different electrolytes with different etching times;
FIG. 53A shows the concentrations of selected components on LCO surface after 50 cycles in baseline electrolyte with different etching times;
FIG. 53B shows the concentrations of selected components on LCO surface after 50 cycles in designed electrolyte with different etching times;
FIG. 54 shows the HR-TEM patterns of LCO particles cycled in baseline (left) and designed electrolyte (right) after 200 cycles;
FIG. 55A shows the atomic percentage of different elements on LCO surface after 200 cycles in baseline electrolyte;
FIG. 55B shows the atomic percentage of different elements on LCO surface after 200 cycles in designed electrolyte;
FIG. 56 shows the HR-TEM images of the LCO surface after 200 cycles with the baseline (left) and designed (right) electrolytes, including corresponding FFT patterns;
FIG. 57 shows the in-situ Raman spectra of LCO particles during the first cycle using different electrolytes; and
FIG. 58 is a schematic diagram illustrating the mechanism by which the designed electrolyte improves the electrochemical performance of the graphite||LCO full cells.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

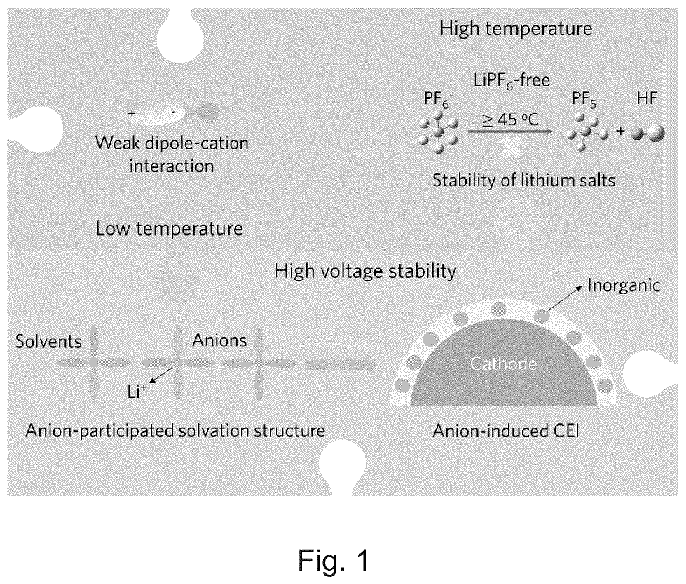

Without wishing to be bound by theory, the inventors have, through their own research, trials, and experiments, devised an electrolyte by cation-anion solvation engineering strategy that may simultaneously address low-temperature ionic conductivity and high-temperature/high-voltage stability. The salt and the solvent may synergistically minimize Li⁺-solvent binding energy and foster anion-participated Li⁺ solvation structures. In particular, as illustrated in FIG. 1, the devised electrolyte may have the following characteristics: (1) weak cation-dipole interactions between solvents and Li⁺ to facilitate the Li⁺ de-solvation process; (2) excellent thermal stability of the lithium salts to minimize the generation of corrosive byproducts; and (3) anion-participated solvation structure to create a robust, inorganic-rich CEI to stabilize the cathode interfacial stability during high-voltage operations. As a result, as illustrated in some example embodiments of the present disclosure, the electrolyte may exhibit ultrahigh ionic conductivity (0.19 mS cm⁻¹ at −60 °C) and fluidity (freezing point <−90 °C) at subzero temperatures. In some other example embodiments, the electrolyte may enable a cathode such as an LCO cathode to exhibit capacity retentions of 88.9% and 77.3% after 400 and 200 cycles at 4.6 V (vs. Li/Li⁺) under 25 °C and 45 °C, respectively.

In some further example embodiments, the electrolyte may enable a cathode such as an LCO cathode to exhibit a reversible capacity of 110.1 and a discharge capacity of 92.6 mAh g⁻¹ are delivered under −35 °C at 0.33 C and under −60 °C at 0.05 C, respectively.

In a first aspect of the present invention, there is provided an electrolyte for lithium-based battery. As used herein, the term “lithium-based battery” generally denotes a battery or cell that stores or releases energy using lithium chemistry, such as the full-cell and half-cell configurations of lithium-ion batteries/cells and lithium-metal batteries/cells. The electrolyte as described herein may comprise at least three lithium salts and a carbonate solvent mixture, wherein the at least three lithium salts are selected from the group consisting of lithium tetrafluoroborate (LiBF₄), lithium difluorooxalate borate (LiDFOB), lithium difluorodioxalate phosphate (LiDFBP), lithium bisfluorosulfonimide (LiFSI) and lithium bis((trifluoromethyl)sulfonyl)azanide (LiTFSI). In some particular embodiments, the at least three lithium salts may include LiBF₄, LiDFOB, and LiDFBP. In some exemplary embodiments, the at least three lithium salts may be a ternary lithium-salt system, particularly a ternary lithium-salt system of LiBF₄, LiDFOB, and LiDFBP. Although it is believed that the ternary lithium-salt system may deliver relatively optimized performance in terms of ionic conductivity, decomposition temperature and solid-electrolyte interphase formation ability, without wishing to be bound by theory, it is also believed that in some other exemplary embodiments, systems with four or more lithium salts may be used to achieve a similar performance as the ternary lithium-salt system. In some embodiments where the at least three lithium salts is a ternary lithium-salt system of LiBF₄, LiDFOB, and LiDFBP, the LiBF₄, LiDFOB, and LiDFBP may each have a molar percentage of at least 10%, provided that the total percentage/proportion of these salts is 100%. In some exemplary embodiments, the lithium tetrafluoroborate (LiBF₄), lithium difluorooxalate borate (LiDFOB), lithium difluorodioxalate phosphate (LiDFBP) may have a molar ratio of about 4:4:3 (e.g., 3.9:4:3, 3.9:3.9:3, 3.9:4:3.1, 4:4.1:3, 4:4:2.9, 3.9:4.1:2.9 and the like).

The at least three lithium salts may have a total concentration from about 0.5 M to about 1.5 M, such as from 0.48 . . . 0.486 . . . 0.49 . . . 0.49 . . . 0.493 . . . 0.498 . . . 0.5 . . . 0.5 . . . 0.502 . . . 0.505 . . . 0.51 . . . 0.8 . . . 0.86 . . . 0.9 . . . 1 . . . 1.04 . . . 1.5 . . . 1.52 M and the like. In some particular embodiments, the at least three lithium salts may have a total concentration of about 1.1 M, such as 1.06, 1.07, 1.08, 1.09, 1.1, 1.11, 1.12, 1.13, 1.14 M and the like.

The term “carbonate solvent mixture” generally describes a mixture of carbonate ester (or organic carbonate or organocarbonate) that is particularly suitable acting as a solvent in lithium-based batteries. In some particular embodiments, the carbonate solvent mixture may include propylene carbonate (PC), ethyl methyl carbonate (EMC), dimethyl carbonate (DMC), and fluoroethylene carbonate (FEC). In particular, the propylene carbonate (PC), ethyl methyl carbonate (EMC), dimethyl carbonate (DMC), and fluoroethylene carbonate (FEC) may have a volume ratio of a: b: c: d, where a is about 2-5, b is about 3-5, c is about 1-3, d is about 1-2, with a+b+c+d =1. For example, in some embodiments, the volume ratio may be about 5:3:1:1, 2:5:1:2, 2:5:2:1, 2:3:3:2 and the like.

It is believed that in typical electrolytes for lithium-based batteries (e.g., LIBs), the lithium ion (Li⁺) is associated with solvent molecules and the electrode-electrolyte (or electrolyte-electrode) interphase (EEI) predominantly originates from the decomposition of solvents. Without wishing to be bound by theory, the inventors have unexpectedly devised that the anions of the at least three lithium salts of the electrolyte as described herein may be more preferably binding with the Li⁺, facilitating the formation of an anion-induced EEI via an anion-involved Li⁺solvation structure. In addition, when the Li⁺ is bound to the carbonate solvent mixture as described herein, the electrostatic attraction between anions and Li⁺ weakens the cation-dipole interaction between the solvent and the Li⁺, which in turn lowers the energy barrier for Li⁺ de-solvation and enhances Li⁺interfacial transfer kinetics. As a result of the synergistic action of the lithium salts and the carbonate solvent mixture as described herein, it is believed that the electrolyte as described herein may exhibit various advantageous electrochemical performance. In one example embodiment, the decomposition voltage of the electrolyte may be about 4.43 V (e.g., 4.41 V, 4.42 V, 4.43 V, 4.44 V, 4.45 V and the like) (vs. Li/Li⁺) under a measurement of linear sweep voltammetry (LSV) with a cutoff current density of about 4 μA cm⁻² (e.g., 3.8 μA cm⁻², 3.85 μA cm⁻², 3.9 μA cm⁻², 3.94. μA cm⁻², 3.98 μA cm⁻², 4 μA cm⁻², 4.01 μA cm⁻², 4.1 μA cm⁻², 4.15 μA cm⁻² and the like). In another example embodiment, the electrolyte may maintain liquid form under a temperature from about −80 °C to about 45 °C (e.g., from −80.5 °C to 45 °C, from −80.5 °C to 45.5 °C, from −80 °C to 45.9 °C, from −81 °C to 46 °C, from −79.9 °C to 45 °C, from −79.5 °C to 45 °C, from −80.5 °C to 44.6 °C, from −79 °C to 44.8 °C, and the like). In yet another example embodiment, the electrolyte may be stable (i.e., without showing any substantial degradation) below or at about 80 °C for at least 140 hours.

Optionally or additionally, in some embodiments, the electrolyte may further comprise an additive, particularly an additive for solid-electrolyte interphase (SEI) formation, selected from the group consisting of vinylene carbonate (VC), 1,3-propanesultone (PS), difluorocarbonated ethylene carbonate (DFEC), tri-(tri-methyl-silane) borate (TMSB), methylene methanedisulfonate (MMDS), and tri-(tri-methyl-silane) phosphate (TMSP), and a combination thereof. In particular, mass of the additive may be 5% or less of the total mass of the electrolyte.

The electrolyte as described herein is particularly suitable for lithium-based battery. In a second aspect of the present invention, there is provided a lithium-based battery comprising: a cathode comprising a cathode active material selected from the group consisting of lithium cobalt oxide (LCO), lithium iron phosphate (LFP), lithium manganate (LMO), lithium iron phosphate with manganese added (LMFP), nickel-rich NCM, nickel-rich NCA, and graphite; an anode; and an electrolyte comprising at least three lithium salts selected from lithium tetrafluoroborate (LiBF₄), lithium difluorooxalate borate (LiDFOB), and lithium difluorodioxalate phosphate (LiDFBP), and a carbonate solvent mixture selected from the group consisting of propylene carbonate (PC), ethyl methyl carbonate (EMC), dimethyl carbonate (DMC), and fluoroethylene carbonate (FEC). In some embodiments, the cathode may comprise cathode active material of LCO and the anode comprises an anode active material selected from the group consisting of graphite, silicon, lithium metal, silicon-carbon composite, and silicon dioxide. In some other embodiments, the cathode comprises a cathode active material of graphite and the anode has an anode active material selected from the group consisting of lithium metal, silicon, silicon-carbon composite, and silicon dioxide. It is appreciated that the lithium-based battery as described herein may be configured as a half-cell or a full-cell, depending on the materials employed for the cathode and the anode. For example, in the embodiments where the lithium-based battery comprises an LCO cathode (i.e., a cathode with a cathode active material of LCO), the battery may be configured as a half-cell by using a lithium metal anode (i.e., an anode with an anode active material of lithium metal). On the other hand, the battery with the LCO cathode may be configured as a full-cell by using a graphite anode (i.e., an anode with an anode active material of graphite). Similarly, in the embodiments where the lithium-based battery comprises a graphite cathode (i.e., a cathode with a cathode active material of graphite), the battery may be configured as a half-cell using a lithium metal anode.

The cathode as described herein may comprise the cathode active material as described herein, a conductive carbon, a binder, and a current collector. Similarly, the anode as described herein may comprise the anode active material as described herein, a conductive carbon, a binder, and a current collector. Examples of conductive carbon material may include Ketjen Black, Super P, Super P-Li and the like. Examples of binder material may include carboxymethylcellulose (CMC), carboxymethylcellulose sodium (CMC-Na), polyacrylic acid (PAA), polyacrylic acid lithium (PAA-Li), styrene butadiene rubber (SBR), polyvinylidene fluoride (PVDF) and the like. Examples of current collector material may include copper, aluminum and the like.

In some example embodiments, the cathode may comprise 70 wt. % graphite, 20wt. % Super P, 4 wt. % sodium carboxymethyl cellulose (CMC) and 6 wt. % styrene butadiene rubber (SBR). In some other example embodiments, the cathode may comprise 90 wt. % LCO, 5 wt. % Super P and 5 wt. % polyvinylidene fluoride (PVDF). In some example embodiments, the anode may comprise 94.5 wt % graphite, 2.5 wt % Super P, 1.5 wt % CMC and 1.5 wt % SBR.

The mass loading of the cathode and the anode may be different. In particular, the mass loading of the cathode may be of about 6.6 mg cm⁻², such as 6.57 mg cm⁻² . . . 6.59 mg cm⁻², 6.6 mg cm⁻², 6.61 mg cm⁻² . . . 6.63 mg cm⁻² and the like, whereas the mass loading of the anode may be of about 2.0 mg cm⁻² to about 4.0 mg cm⁻², such as 1.85 mg cm⁻² . . . 1.9 mg cm⁻² . . . 1.99 mg cm⁻² . . . 2.0 mg cm⁻² . . . 2.2 mg cm⁻² . . . 3.85 mg cm⁻² , 3.95 mg cm⁻² , 4.0 mg cm⁻² , 4.05 mg cm⁻² , 4.1 mg cm⁻² , 4.19 mg cm⁻² and the like. In some embodiments where the battery is a half-cell, the anode's mass loading may be reduced to half that of a full-cell. For example, the mass loading of the anode may be decreased from 4.0 mg cm⁻² in a full-cell to 2.0 mg cm⁻² in a half-cell.

The lithium-based battery as described herein may be advantageously to have an average Coulombic efficiency of at least 99% when operated at a voltage of at least 4.6 V under a temperature of about 45 °C (e.g., 43.6 °C . . . 44 °C . . . 44.8 °C . . . 45 °C . . . 45.2 °C and the like).

Without wishing to be bound by theory, the inventors have devised that the above unexpected battery performance may be attributed to the electrolyte as described herein. As mentioned, the electrolyte as described herein may be particularly advantageous in the formation of an electrode-electrolyte (or electrolyte-electrode) interphase that may stabilize the anode's and cathode's surficial structure. For example, in some particular embodiments, the electrolyte may be arranged to form a cathode-electrolyte interphase (CEI) on the cathode at a voltage of about 4.6V for stabilizing interfacial phase of said cathode under said high voltage. The CEI may be uniformly disposed on the cathode surface and may have a thickness from about 7 nm to about 20 nm, such as from 6.9 nm to 20 nm, from 6.9 nm to 20.2 nm, from 6.88 nm to 20 nm, from 6.91 nm to 20 nm, from 6.9 nm to 19.9 nm, from 6.95 nm to 20 nm, from 7 nm to 21 nm, from 7.2 nm to 20.1 nm, from 7 nm to 20 nm and the like. The CEI may particularly comprise LiF in a concentration gradient such that the LiF concentration is higher at a side proximal to the cathode surface than at a side distal from the cathode surface. Without wishing to be bound by theory, it is believed that with a higher concentration of LiF closer to the cathode surface, it will be more effective to inhibit the irreversible interfacial phase transition/transformation of the cathode at high voltage such as at 4.6 V. Additionally, in some embodiments, the CEI may further comprise other inorganic species, such as P-O and B-O species, that may further enhance the stability of the CEI, facilitating the inhibition of continuous electrolyte decomposition, particularly at high temperatures such as at about 45 °C or above.

Hereinafter, the present invention is described more specifically by way of examples, but the present invention is not limited thereto.

### EXAMPLES

### Materials

LCO electrode was purchased from WeiMing Co., Ltd., China. Graphite material was purchased from Shenzhen BTR Tech Co., Ltd., China. The baseline electrolyte consisting of 1.0 M LiPF₆ in EC/EMC/DMC=1/1/1, by vol. was purchased from DodoChem. The solvents of PC, EMC, DMC, FEC and the lithium salts of LiBF₄ and LiDFOB were purchased from DodoChem. The lithium salt of LiDFBP was purchased from the Changsha T-rock Biochem Co., LTD. The designed electrolyte (i.e. the electrolyte of this work) comprised 0.4 M LiBF₄, 0.4 M LiDFOB and 0.3 M LiDFBP in PC/EMC/DMC/FEC=2/3/3/2, by vol. In an example embodiment, the cathode for half-cells comprised 90 wt. % LCO, 5 wt. % Super P and 5 wt. % polyvinylidene fluoride (PVDF) while the anode is lithium metal. In another example embodiment, the cathode for half-cells comprised 70 wt. % graphite, 20 wt. % Super P, 4 wt. % sodium carboxymethyl cellulose (CMC) and 6 wt. % styrene butadiene rubber (SBR) while the anode is lithium metal. The mass loadings of the cathode and anode for half-cells were 6.6 and 2.0 mg cm⁻², respectively. The mass loading of the cathode and anode for full-cells were 6.6 and 4.0 mg cm⁻² respectively. The anode for full-cells was composed of 94.5 wt% graphite, 2.5 wt % Super P, 1.5 wt % CMC and 1.5 wt % SBR.

### Electrochemical Measurements

Coin cells were assembled by CR2032 in the argon-filled glovebox with Celgard 2400 (19 mm diameter) as the separator. 80 μl of electrolyte was added to each cell. The assembled coin cells were tested on a NEWARE battery test system. For the long-cycling performance, the coin cells were tested using the constant current charging and discharging profiles and 10 s rest was implemented after every step. Liner sweep voltammetry (LSV) was tested on the Solartron Analytical 1470E electrochemical workstation with a scan rate of 0.5 mV s⁻¹. The ionic conductivity of different electrolyte was calculated by the Rs impedance of the three-electrode model under different temperatures. The ionic conductivity of the electrolytes was calculated using the following formula:

σ=αa/Rs

where σ represents the ionic conductivity, Rs is the measured impedance and a is the constant which is obtained by the subsequent formula:

α=σ′*Rs′

where σ′ is the ionic conductivity of the baseline electrolyte at 25 °C obtained from the seller and Rs′ is the impedance of the baseline electrolyte at 25 °C. The material of the three electrodes is titanium with an area of 0.785 cm⁻². EIS was conducted over a frequency range of 1000 kHz to 0.1 Hz with an AC signal amplitude of 10 mV. To ensure accurate temperature control and thermal equilibration, the assembled cells were stored at the target temperature for at least four hours before the EIS test.

### Characterization

Nuclei magnetic resonance (NMR) spectra (¹H NMR, ⁷Li NMR and ¹⁹F NMR) were recorded using Bruker DPX 300 MHz spectrometers. A scanning electron microscope (SEM, Zeiss SUPRA-55) was used for the investigation of the morphology and elemental distribution of the samples. TEM samples were prepared using the FIB, and HR-TEM was performed using a JEM-100F microscope. X-ray photoelectron spectrometry (XPS) on a Thermo Scientific Escalab 250Xi spectrometer was used to investigate the chemical states of the selected elements. In-situ FTIR spectra were documented by NICOLET iS50 Frontier-FTIR Spectrometer (Thermos Scientific, America).

### DFT Calculation and MD Simulation

All the DFT computations were finished with the Gaussian 09 package. Four different combinations of density functional methods and basis were performed the binding energy calculation between Li⁺and solvents, including B3LYP/6−31+G(d), B3LYP/6−311++G(d, p), B3LYP/DGDZVPS and M062X/6−311++G(d, p). The Li+-solvent binding energy equals the single-point energy of the Li⁺-solvent compound minus the single-point energy of the corresponding solvent and Li⁺. Basis set of B3LYP/6−311++G(d, p) with DMSO implicit solvent was used to calculate the binding energy between Li⁺and anions. Molecular dynamics simulations were performed in the Material Studio using the universal force field (UFF). The molecular structures were initially calculated by the Gaussian 09 package. Molecular dynamics simulations under the NPT ensemble after steps of energy minimization were implemented using the Nose-Hoover thermostat at 298 K and Berendsen pressure coupling method under 1 atm for 2 ns (1.0 fs time step). Later molecular dynamics simulations under the NVT ensemble after steps of energy minimization were implemented using the Nose-Hoover thermostat at 298 K for 1 ns (1.0 fs time step).

### Example 1

### Synergistic Pairing of Carbonate Solvents and Lithium Salts for Wide-Temperature and High-Voltage Electrolytes

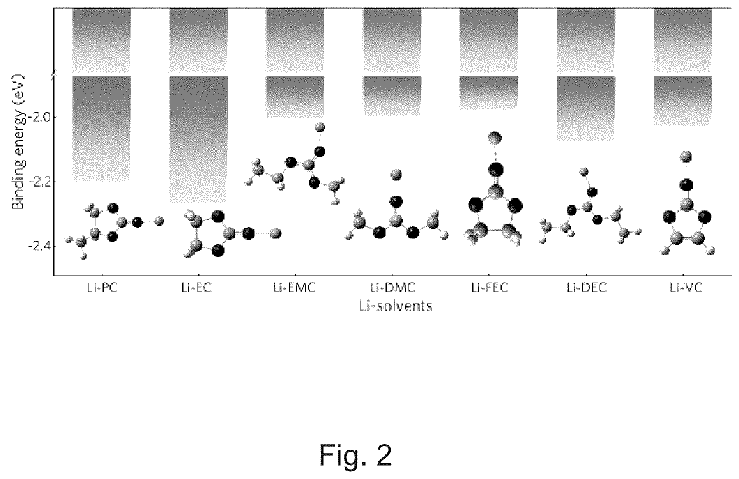

To optimize the carbonate solvents for wide-temperature and high-voltage electrolytes, density functional theory (DFT) calculations were implemented. It is believed that a weaker dipole-cation interaction implies a preferred anion-participated Li⁺ solvation structure and fast Li⁺ de-solvation kinetics, which can be inferred by the lower Li-solvent binding energy. Among the others, it is believed that ethyl methyl carbonate (EMC), dimethyl carbonate (DMC) and fluoroethylene carbonate (FEC) show relatively lower binding energies with Li⁺ (FIG. 2), theoretically enabling faster Li⁺ de-solvation kinetics and thereby enhancing low-temperature performance.

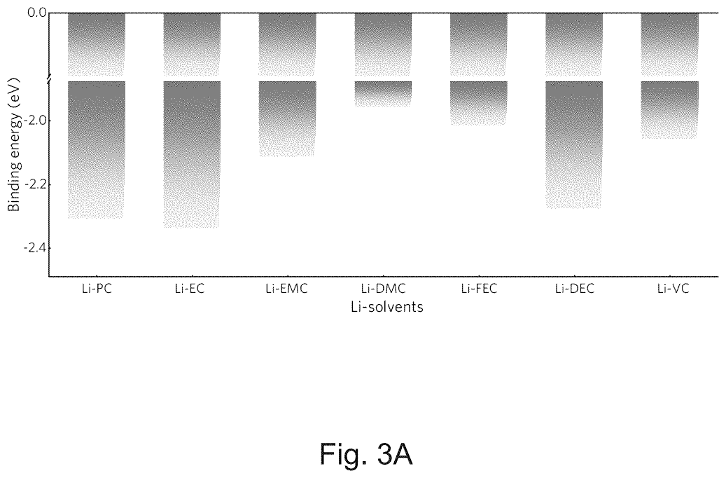

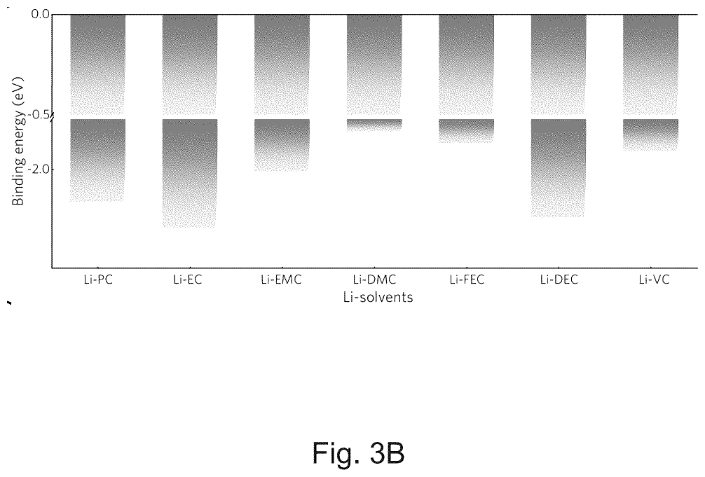

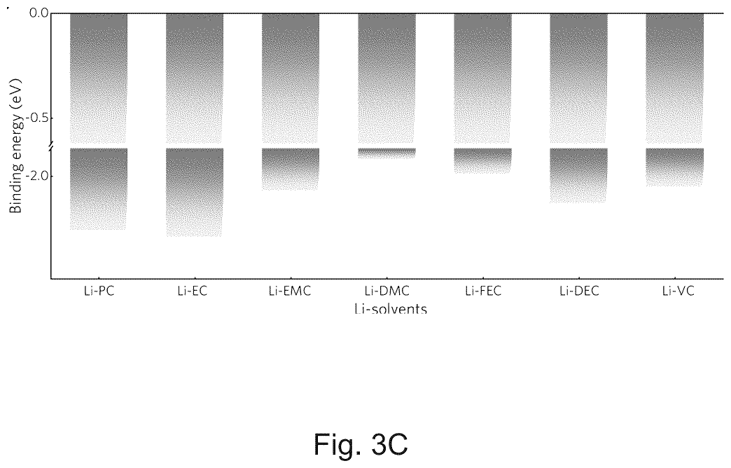

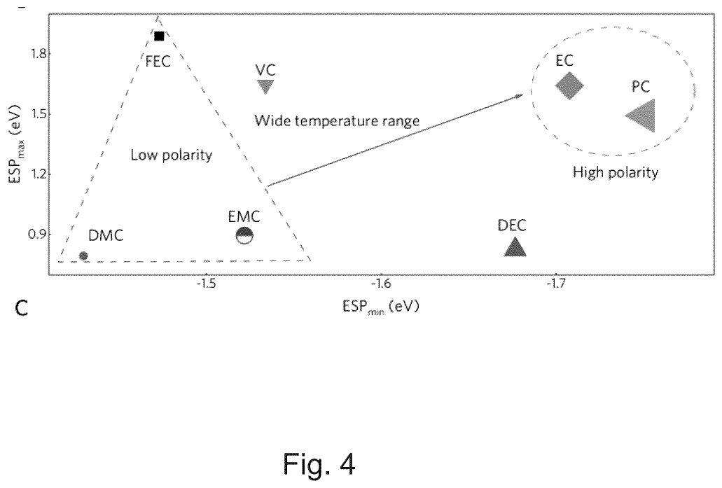

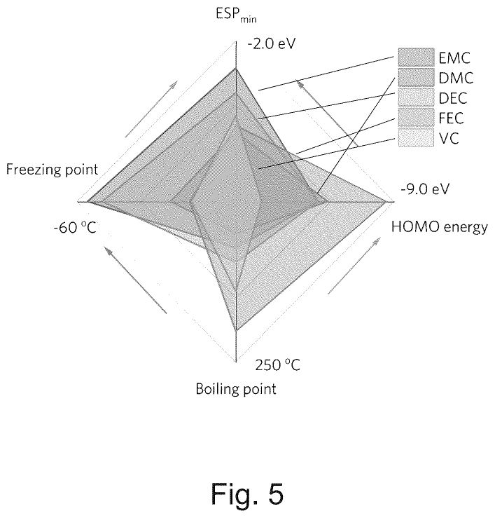

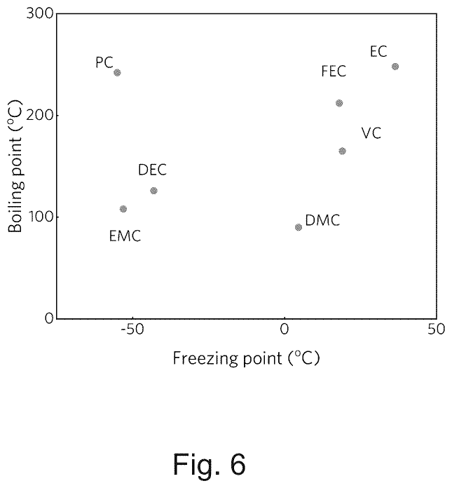

To verify the reliability of this result, three different basis sets were used to conduct the calculation, which show the same distribution trend in Li⁺ -solvent binding energy, indicating the consistency of calculation results (FIGS. 3A to 3C). Moreover, the intrinsic properties of solvents, such as their polarities, were evaluated based on electrostatic potential (ESP) energies. Lower ESPₘₐₓ and ESPₘᵢₙ values denote weaker dipole-cation interactions. Considering this, EMC, DMC and FEC (represented within the triangle in FIG. 4) were identified as favorable solvents for Li⁺ de-solvation, consistent with the results of the Li-solvent binding energies. In addition, the lower Highest Occupied Molecular Orbital (HOMO) energies of these three solvents suggest their enhanced resistance to oxidation at high potentials (FIG. 5). Thus, it is believed that EMC, DMC and FEC could act as the primary solvents for an electrolyte designed to operate at both low temperatures and high voltages. Meanwhile, considering the dissolution of lithium salts and maintaining the ionic conductivity of the electrolyte, the inclusion of high-polarity solvents (shown within the circle in FIG. 4) as co-solvents is preferred. Constrained by the high freezing point of EC (FIG. 6), propylene carbonate (PC) was selected as the preferred co-solvent to improve the wide-temperature stability of the electrolyte.

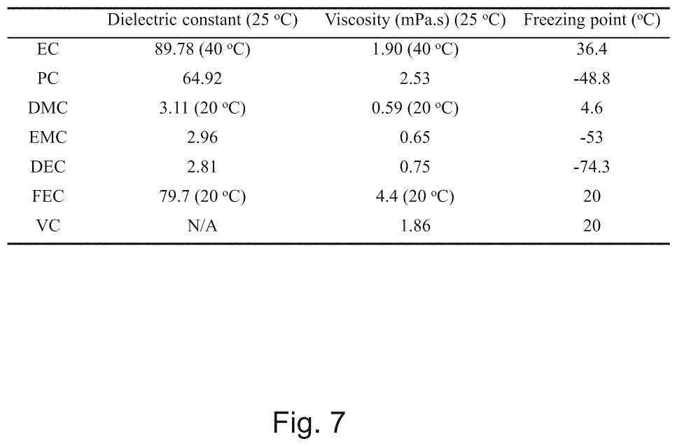

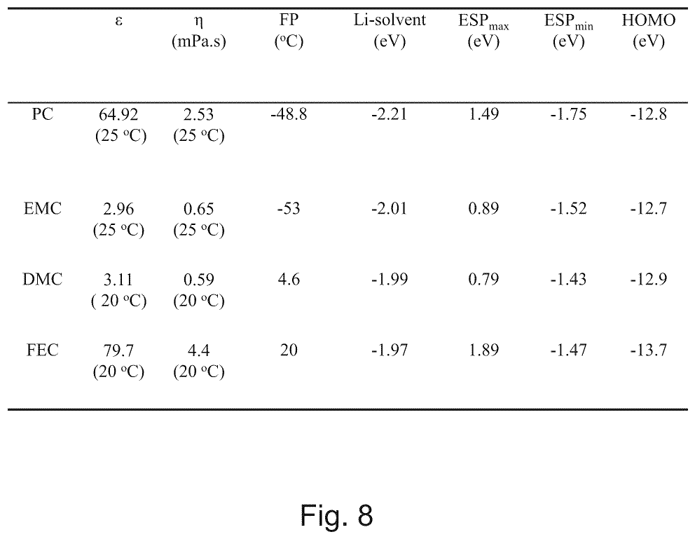

The physical properties of different carbonate solvents are shown in FIG. 7. Both EC and PC possess a high dielectric constant, implying their excellent ability to dissolve lithium salts, consistent with their calculated high polarity. Apart from that, it is believed that low viscosity and freezing point are also essential for enabling the wide temperature performance of LIBs. This endows propylene carbonate (PC) to replace EC as a promising carbonate solvent to ensure the dissociation of lithium salts, while EMC and DMC serve as co-solvents to reduce the viscosity of the electrolyte. Considering its acknowledged protective effect, FEC is also essential to act as the co-solvent (FIG. 8). After a comprehensive evaluation of various indicators, the solvents PC, EMC, DMC and FEC were chosen for the designed electrolyte, combining the advantages of wide-temperature performance, high-voltage stability, and enhanced ionic conductivity.

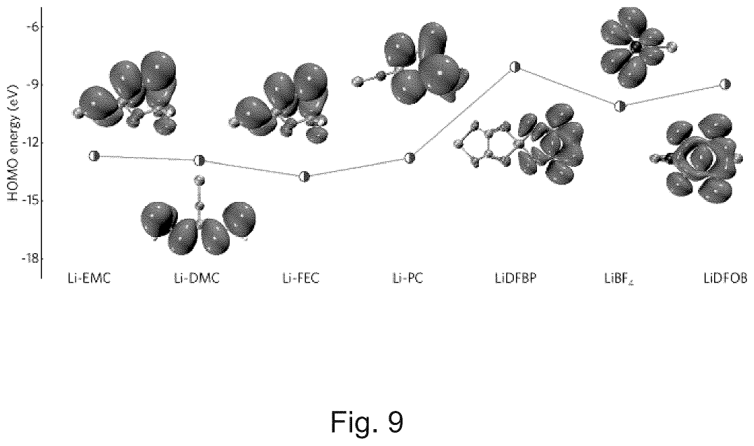

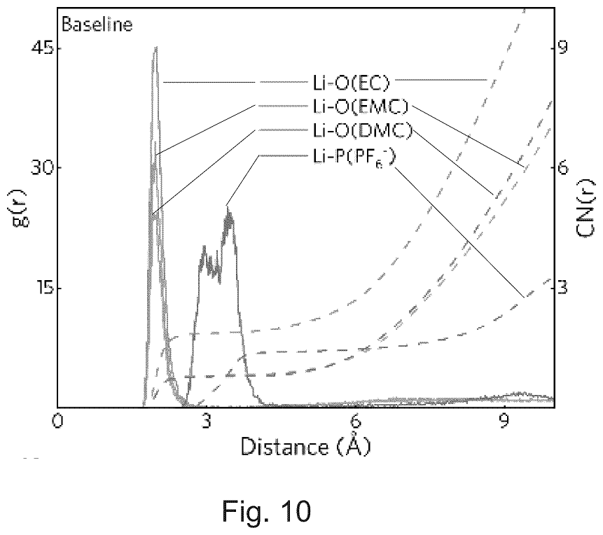

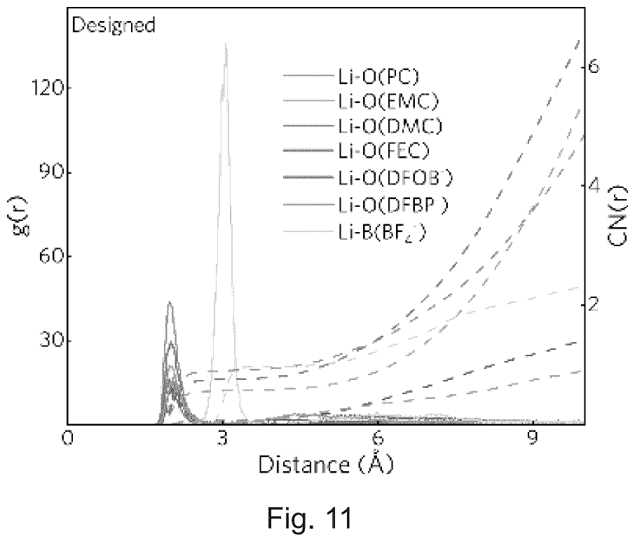

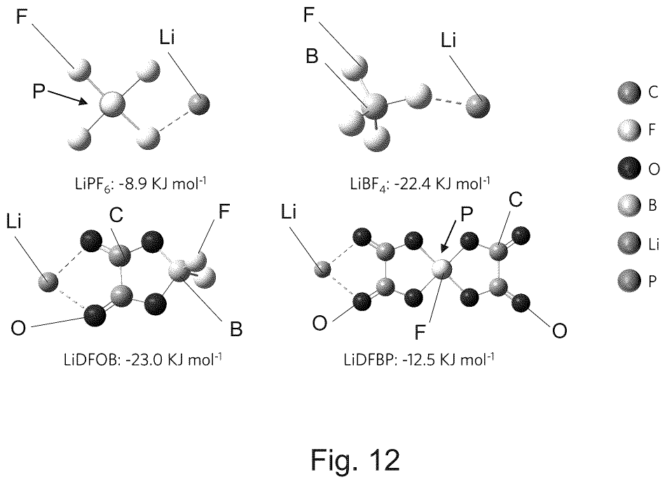

Given the stability of lithium salts at elevated temperatures, LiBF₄, LiDFOB and LiDFBP were chosen as the main lithium salts for the designed electrolyte to promote the anion-induced CEI formation and thermal stability of the electrolyte. To substantiate this selection, DFT calculations and molecular dynamics (MD) simulations were executed. It is believed that in diluent electrolytes, Li⁺ is typically associated with solvent molecules. The CEI in baseline electrolyte predominantly originates from the decomposition of solvents. However, when the DFBP⁻ and DFOB⁻ anions bind to Li⁺, their elevated HOMO energies suggest that the designed electrolyte has a high potential to form anion-induced CEI via an anion-involved Li⁺ solvation structure (FIG. 9). To further investigate this, MD simulations were performed for both baseline and designed electrolytes. For the baseline electrolyte, solvents predominantly constitute the first solvation sheath of Li⁺ (FIG. 10). In contrast, the designed electrolyte showcases a Li⁺ solvation structure that involves DFOB⁻ and DFBP⁻, facilitating the formation of an anion-induced CEI (FIG. 11). This change in the solvation structure is attributed, on the one hand, to the relatively low Li⁺ -solvent binding energies of the tailored solvents. On the other hand, the stronger cation-anion interactions provided by the selected lithium salts with high thermal stability further promote the formation of this unique anion-involved solvation structure (FIG. 12).

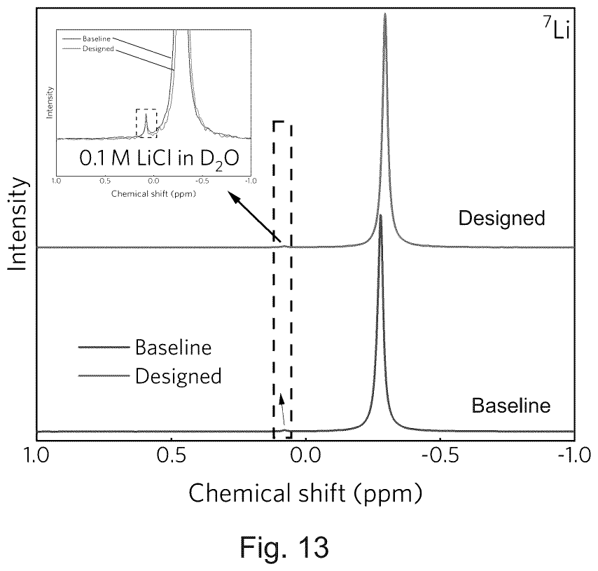

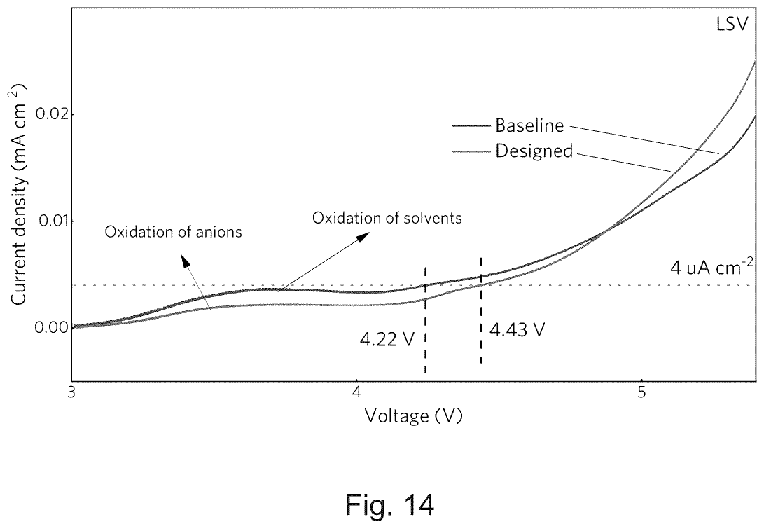

The ⁷Li nuclear magnetic resonance (NMR) spectra confirm the modified Li⁺ solvation structure of the designed electrolyte (FIG. 13). Compared with the baseline electrolyte, the ⁷Li NMR spectra of the designed electrolyte slightly shift to a lower frequency, indicating an enhanced electron-cloud density around Li⁺, mainly caused by the binding with anions. The formation of anion-induced CEI is evidenced by the preferential oxidation peak observed in the linear sweep voltammetry (LSV) profiles of the designed electrolyte (FIG. 14). Moreover, using a cutoff current density of 4 μA cm⁻², the decomposition voltage of the designed electrolyte is 4.43 V (vs. Li/Li⁺), higher than that of the basic electrolyte (4.22 V, vs. Li/Li⁺), demonstrating the higher antioxidant ability of the designed carbonate-based electrolyte.

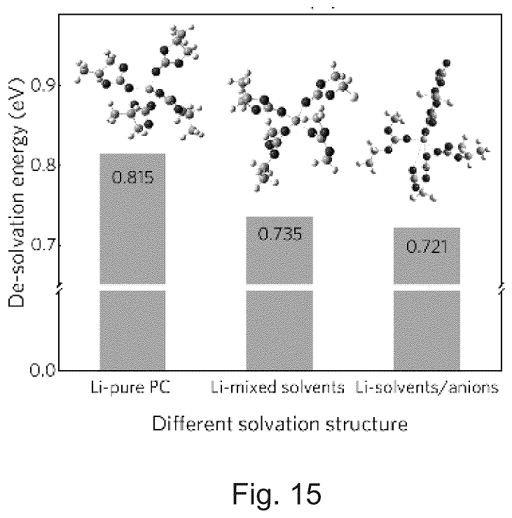

Moreover, to reveal the effect of dipole-cation interactions on Li⁺ de-solvation kinetics, three different solvation structures of Li⁺ were evaluated (FIG. 15). Initially, the Li⁺ de-solvation energy is highest when Li⁺ is bound to the pure solvent (PC) with high polarity, and this energy decreases as weakly polarized solvents (FEC/EMC) participate in the solvation structure. The electrostatic attraction between anions and Li⁺ weakens the cation-dipole interaction, which in turn lowers the energy barrier for Li⁺ de-solvation and enhances Li⁺ interfacial transfer kinetics. These results indicate the importance of designing the weak dipole-cation interactions and anion-involved Li⁺ solvation structure to enhance Li⁺de-solvation kinetics.

### Example 2

### Physicochemical Properties of the Electrolytes

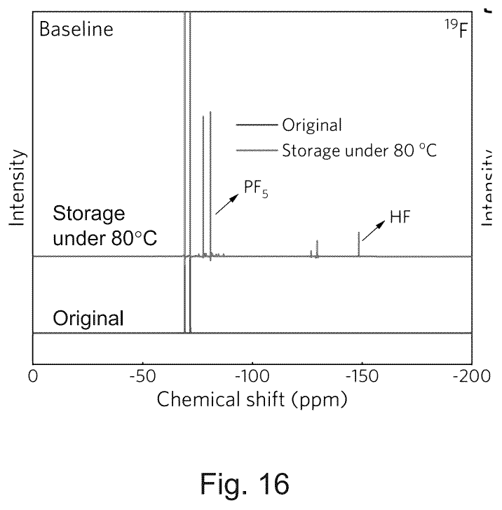

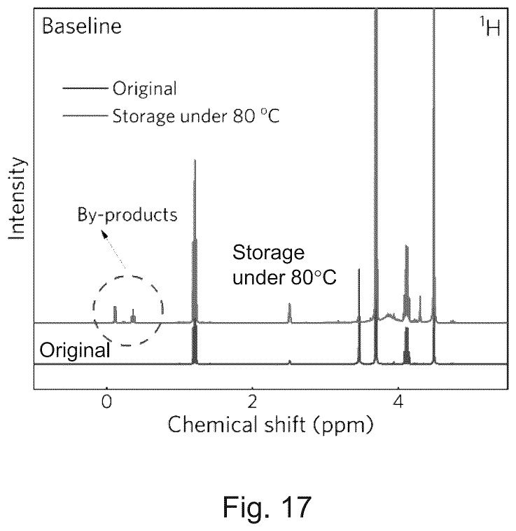

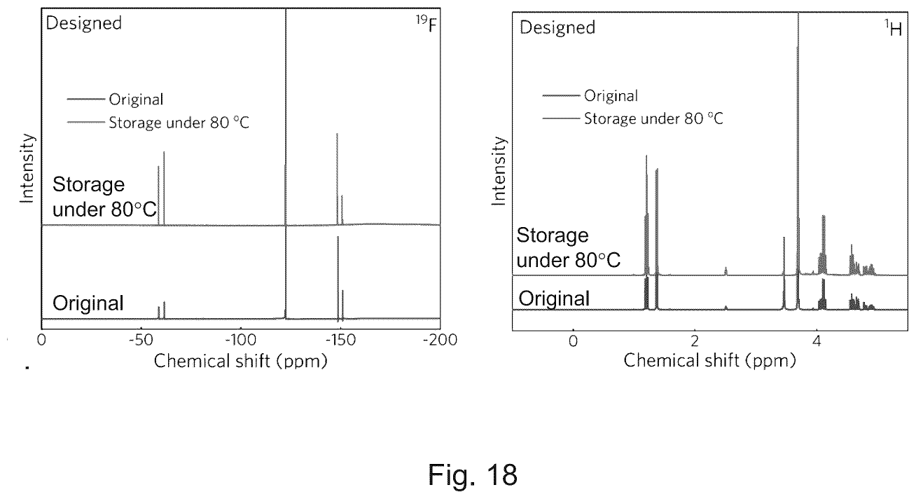

To investigate the potential application of the designed electrolyte in wide-temperature LIBs, the electrolyte's thermal stability and temperature-dependent ionic conductivity were evaluated. Firstly, the designed electrolyte demonstrated negligible thermal decomposition under high temperatures due to the lithium salts with high thermal stability. In contrast, the baseline electrolyte with LiPF₆ showed significant degradation: after 144 hours of storage at 80 °C, the electrolyte turned brown, and the characteristic ¹⁹F nuclear magnetic resonance (NMR) peaks of PF₅ and HF were detected (FIG. 16). This can be attributed to the severe decomposition of LiPF₆ under high-temperature conditions. Meanwhile, new ¹H NMR characteristic peaks, aside from the solvent peaks, appeared in the baseline electrolyte after long-term high-temperature storage, suggesting products from the reaction between carbonate solvents and PF₅ (FIG. 17). These results demonstrate the poor thermal stability of LiPF₆-based electrolytes. Conversely, no discernible decomposition products were observed in the designed electrolyte, showing its superior thermal stability and potential for high-temperature applications (FIG. 18).

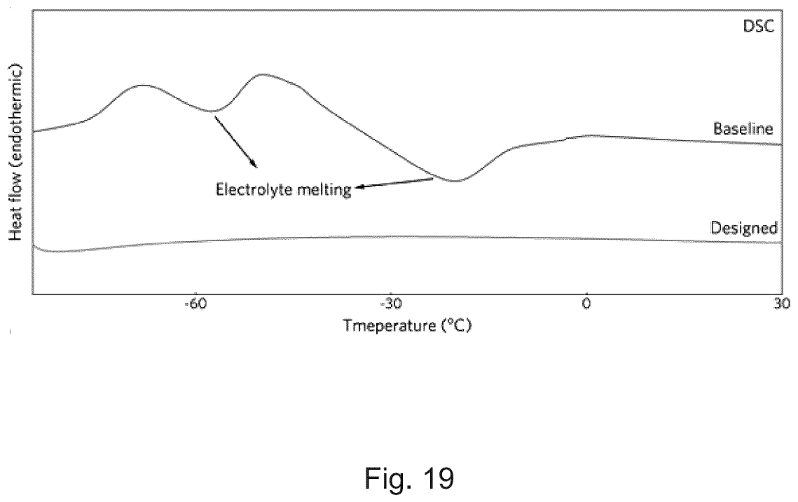

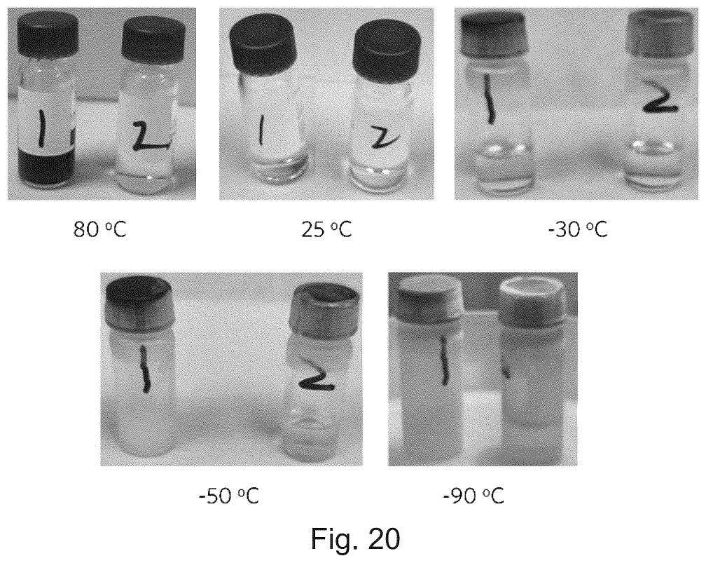

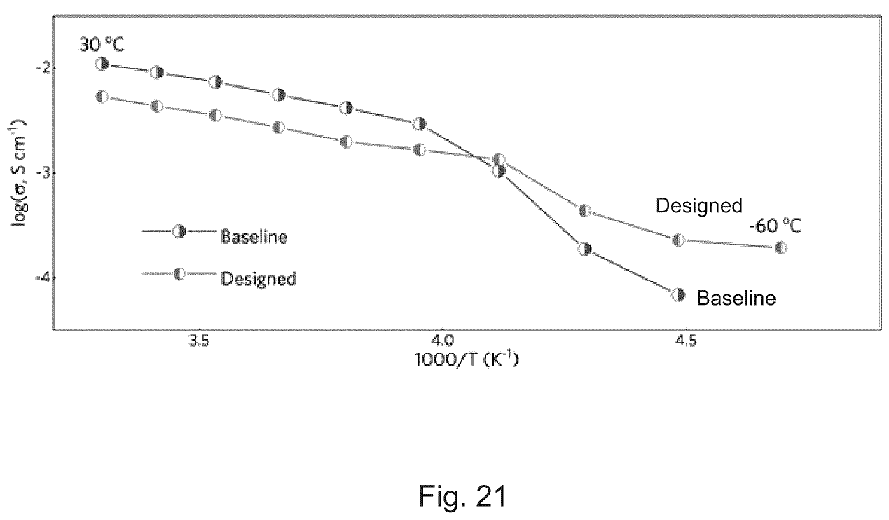

Differential scanning calorimetry (DSC) profiles in FIG. 19 demonstrated that, during the heating process from −85 °C to 30 °C, the baseline electrolyte showed endothermic peaks located at −57.1 °C and −20.1 °C, indicating the solid-liquid phase transformation. Surprisingly, no endothermic peak was observed for the designed electrolyte, indicating it remained in liquid form across the temperature range from −80 °C to 30 °C. It is believed that this behavior is attributed to the judicious selection of solvent blends. The optical photos of the electrolytes at different temperatures further support this: while the baseline electrolyte solidified at −60 °C, the designed electrolyte remained liquid at −90 °C (FIG. 20). Owing to the extremely low freezing point and the moderate lithium salt dissociation ability of the rationally selected solvents, the designed electrolyte exhibits exceptional ionic conductivity at reduced temperatures (FIG. 21). Its high ionic conductivity (0.19 mS cm⁻¹ at −60 °C) indicates its potential for applications in low-temperature environments.

### Example 3

### Electrochemical Performance of the Electrolytes

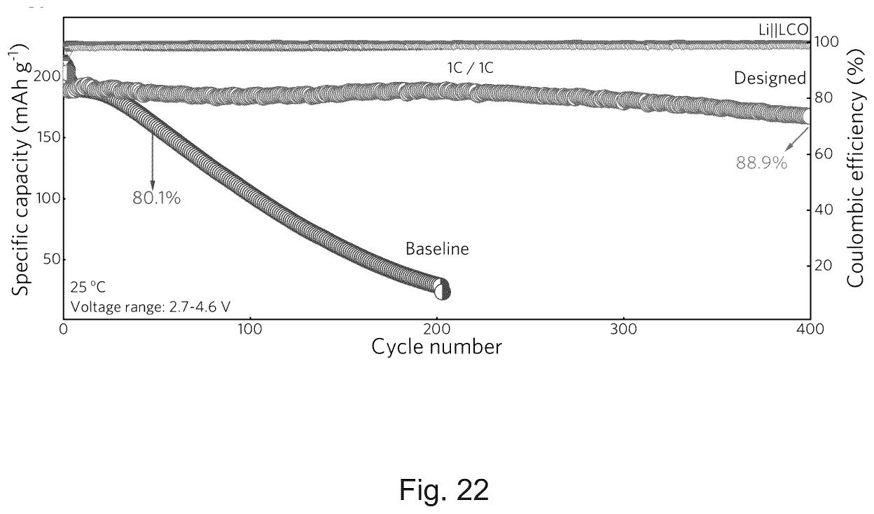

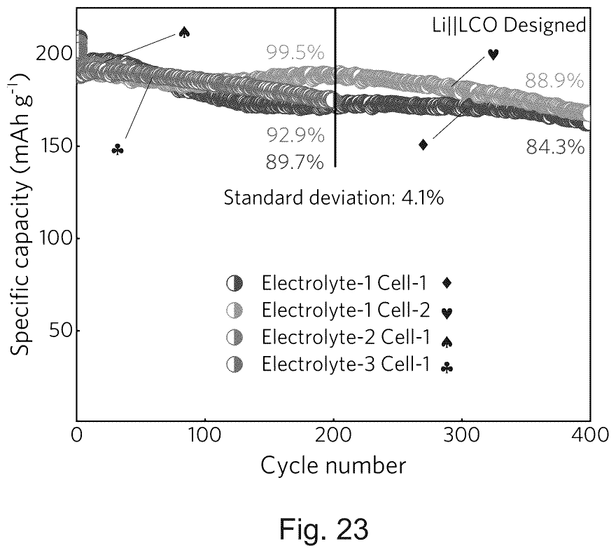

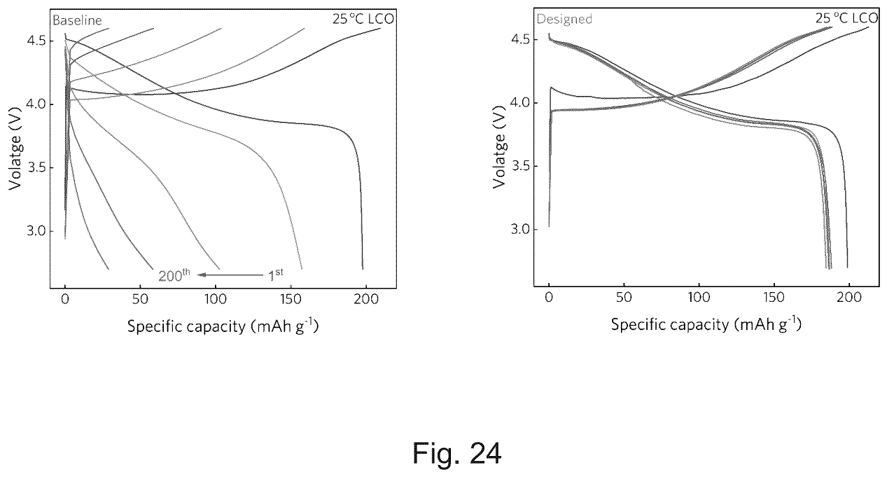

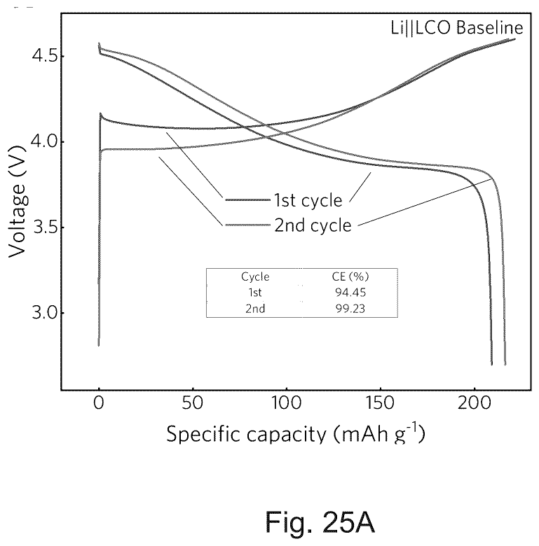

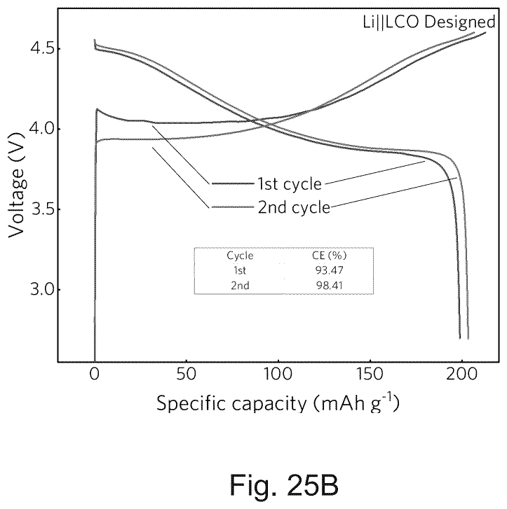

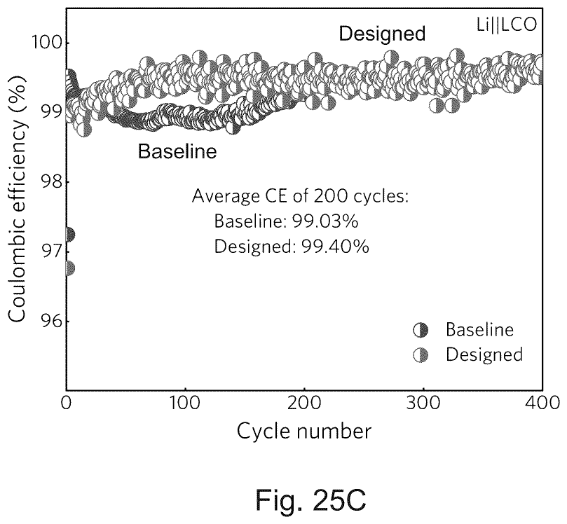

It is believed that the combination of high thermal stability, excellent low-temperature ionic conductivity, and the capability to form an anion-induced CEI endows the designed electrolyte with high application potential for wide-temperature, high-voltage LIBs. To verify this, the electrochemical performance of both LCO and graphite electrodes was tested. With an upper cut-off voltage at 4.6 V (vs. Li/Li⁺), the LCO cathodes cycled in both electrolytes deliver a high reversible capacity of about 190 mAh g⁻¹ with the current density at 1 C after activation. Interestingly, the Li||LCO half-cells using the designed electrolyte achieve excellent long-term cycling stability, retaining 88.9% capacity over 400 cycles at 25 °C (FIG. 22). And the excellent long-term cycling exhibits high reproducibility, as shown in FIG. 23. Li||LCO half cells using different batches of designed electrolyte all exhibit stable long-term cycling performance with a standard deviation of 4.1% after 200 cycles. In contrast, the LCO electrode in the baseline electrolyte undergoes dramatic capacity decay and severe charging/discharging plateau degradation (FIG. 24), with only a reversible capacity of 23.4 mAh g⁻¹ after 200 cycles. Moreover, Li||LCO half cells using the designed electrolyte achieve an average Coulombic efficiency (CE) up to 99.4% (FIGS. 25A to 25 C), higher than that of the baseline electrolyte (99.03%). The slightly lower CE observed during the initial activation cycles with the designed electrolyte can be attributed to the anion-induced CEI formation process, which quickly forms a dense CEI on the LCO surface. These results indicate that the CEI formed by the baseline electrolyte cannot protect LCO from the irreversible phase transformation under high voltages.

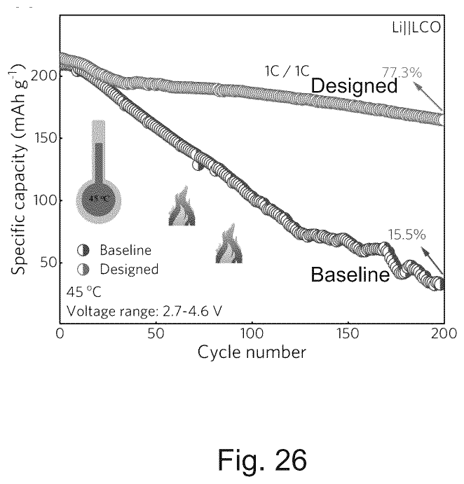

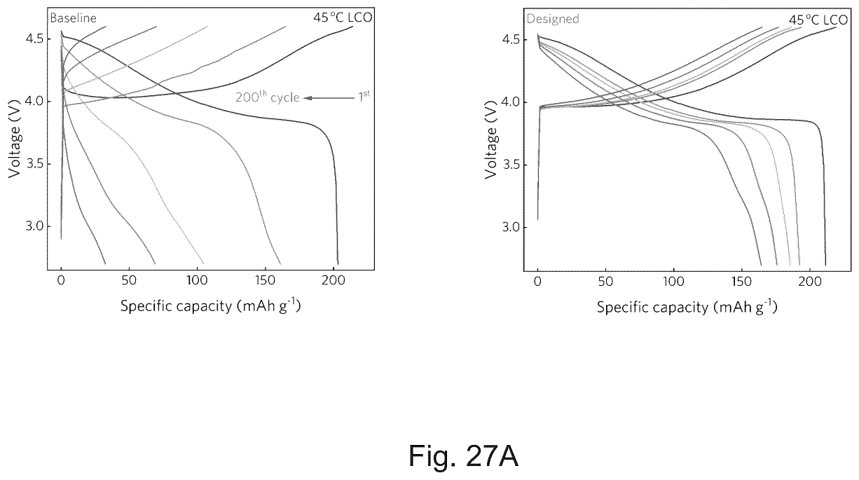

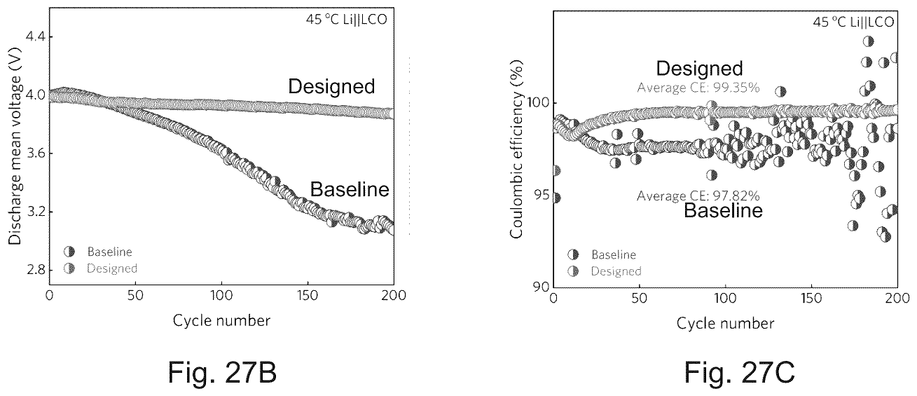

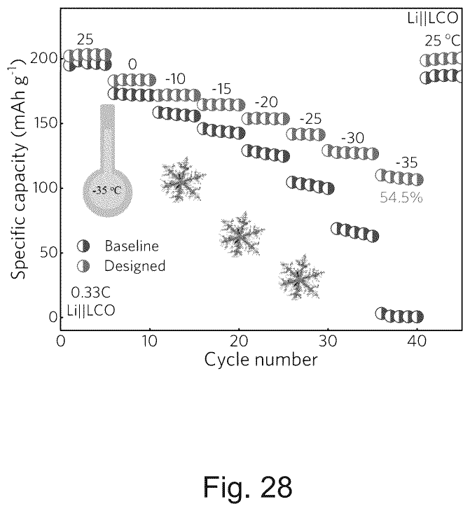

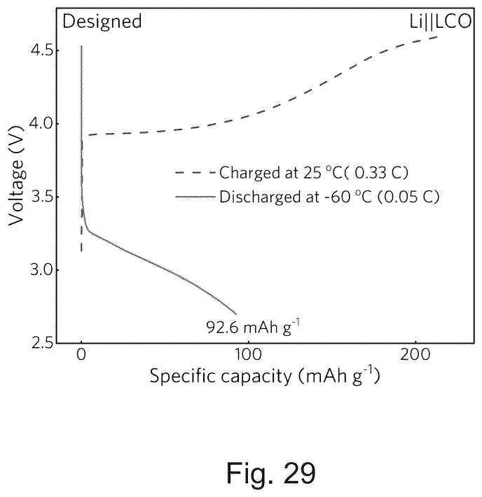

Under elevated temperature conditions (45 °C), the LCO in the baseline electrolyte shows poor cycling performance, retaining only 15.5% capacity after 200 cycles and exhibiting low, fluctuating average CE. This poor performance is primarily due to the unstable CEI formed by the baseline electrolyte. In contrast, owing to the outstanding thermal stability of the designed electrolyte and the formation of anion-induced CEI, LCO cathode with designed electrolyte demonstrates 77.3% capacity retention after 200 cycles at 45 °C (FIG. 26), exhibiting stable discharge voltage and high average CE of up to 99.35% (FIGS. 27A to 27C). More importantly, the high ionic conductivity of the designed electrolyte below 0 °C enables the LCO cathode to deliver high capacity under low temperatures (FIG. 28). Notably, baseline electrolyte delivers reversible capacities of 198.4, 171.8, 156.4, 142.5, 124.6, 101.0, 62.9 and 0.59 mAh g⁻¹ at 25, 0, −10, −15, −20, −25, −30 and −35 °C, respectively, indicating that the baseline electrolyte is nearly inactive at −35 °C. On the contrary, the designed electrolyte endows the LCO cathode to deliver reversible capacities of 202.1, 183.6, 171.9, 164.5, 154.1, 141.3, 129.1 and 110.1 mAh g⁻¹ with the same temperature gradient and a current density at 0.33 C. This corresponds to a significantly high capacity retention of 54.5% at −35 °C (compared with the capacity at 25 °C), clearly demonstrating the wide-temperature advantage of the designed electrolyte. Even at −60 °C, a high discharge specific capacity of 92.6 mAh g⁻¹ is delivered by the LCO cathode in designed electrolyte at a current density of 0.05 C (FIG. 29).

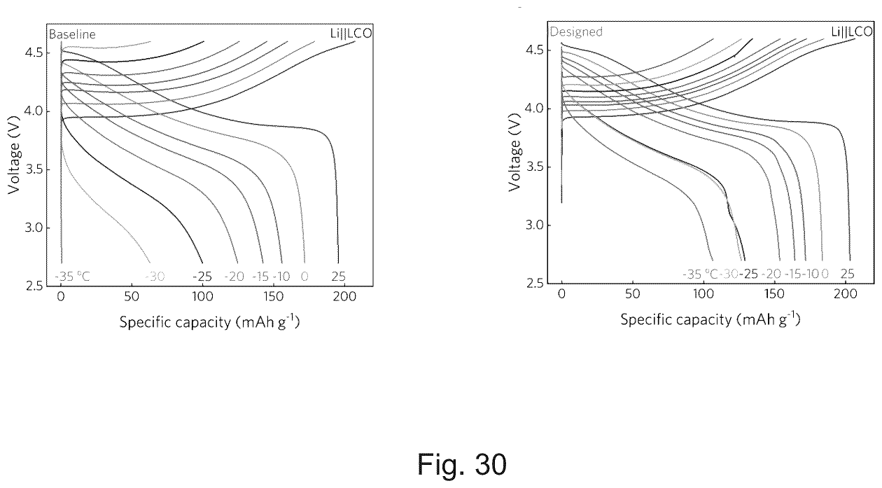

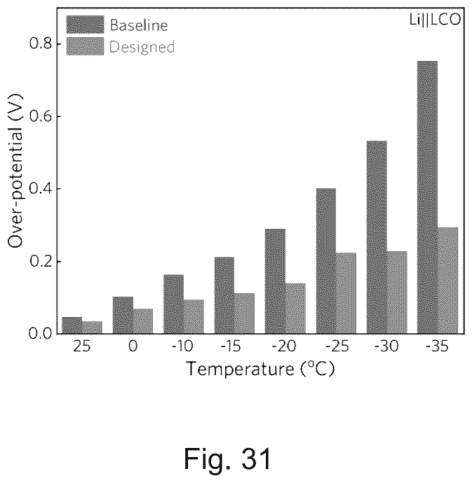

The over-potential of the Li||LCO half-cells using different electrolytes accounts for the significant performance difference, as shown in FIGS. 30 and 31. The over-potential of the Li||LCO half cells using the baseline electrolyte exceeds 0.7 V (vs. Li/Li⁺) at −35 °C, about three times that observed with the designed electrolyte. Such a large overpotential is considered the result of the extremely low ionic conductivity at low temperatures and the sluggish Li⁺ de-solvation process of the baseline electrolyte.

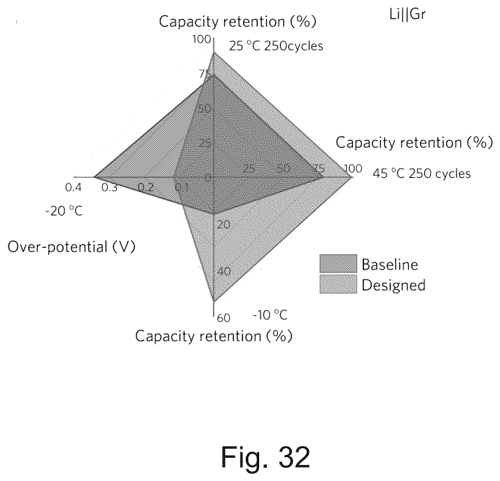

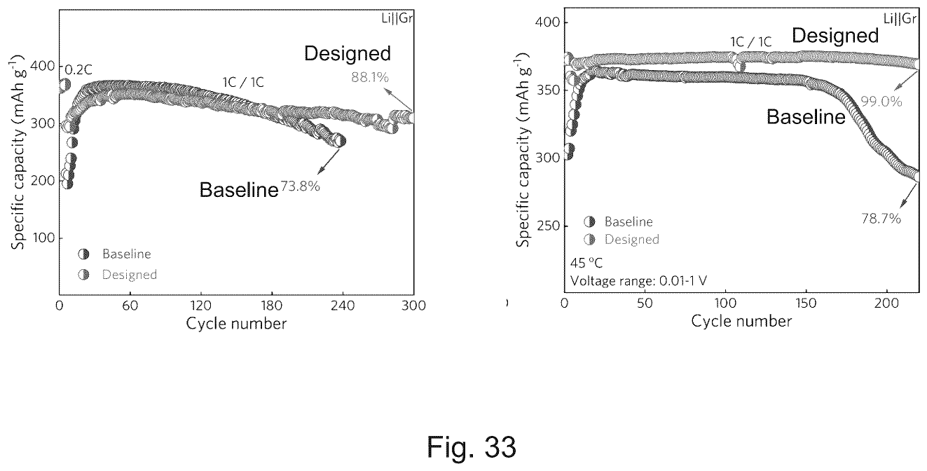

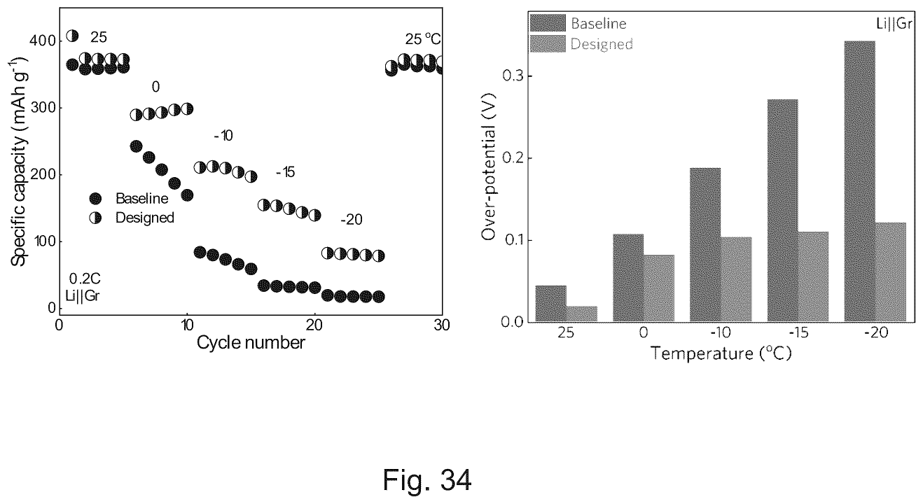

Furthermore, the graphite anode with the designed electrolyte also exhibits excellent electrochemical performance (FIG. 32). At both 25 °C and 45 °C, the graphite anode exhibits superior cycling stability in the designed electrolyte, with negligible capacity decay (FIG. 33). Especially at −10 °C, due to the significantly reduced overpotential, graphite cycling in the designed electrolyte exhibits 212.5 mAh g⁻¹ with a current density at 0.2 C, approximately 3 times the capacity exhibited by that cycling in the baseline electrolyte (FIG. 34). These results demonstrate the potential of the designed electrolyte for use in full cells.

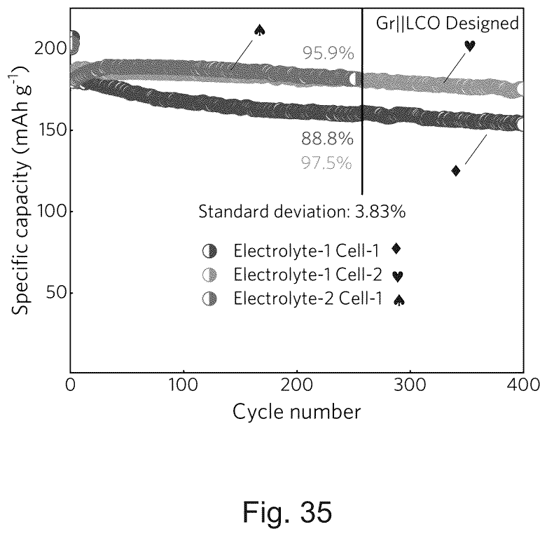

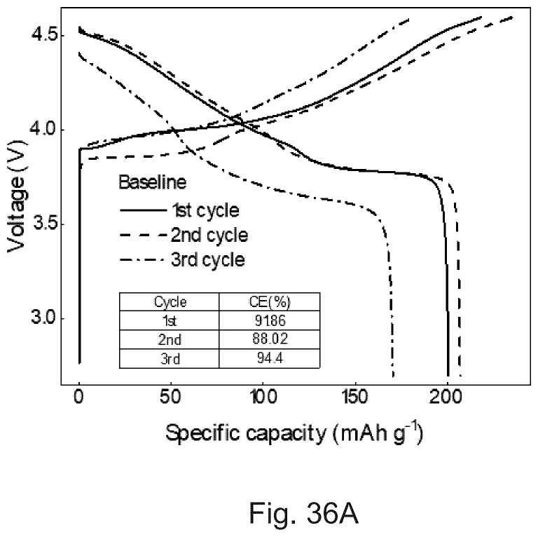

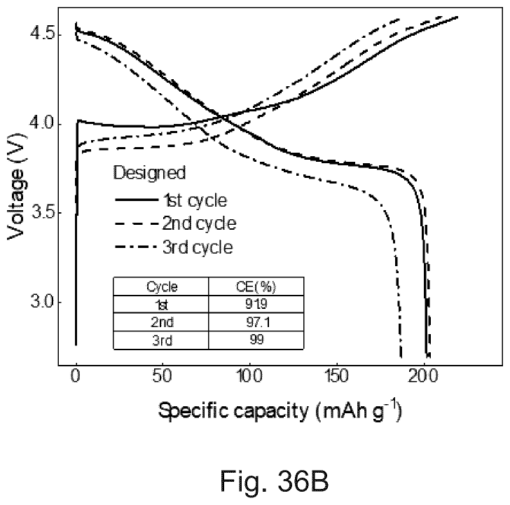

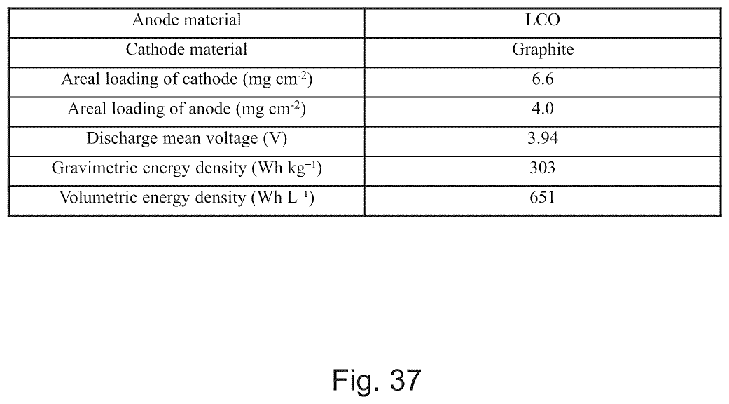

Consequently, the assembled full cells using the designed electrolyte deliver a higher specific capacity of 186.6 mAh g⁻¹ and exhibit superior cycling stability. Specifically, the capacity retention reaches 88.1% over 500 cycles at 4.6 V (vs. Li/Li⁺). To further demonstrate the reproducibility, full cells using different batches of designed electrolytes were assembled, which all exhibit high capacity retention with a standard deviation of only 3.8% after 250 cycles (FIG. 35). Furthermore, the corresponding CE rises to 99.0% after 2 activation cycles (FIGS. 36A and 36B), suggesting minimal electrolyte decomposition. This can be attributed to the excellent CEI-forming ability of the designed electrolyte. As mentioned earlier, the LCO cathode will exhibit a high energy density under the elevated charging cutoff voltage. With the cutoff voltage at 4.6 V (vs. Li/Li⁺), theoretically, the gravimetric and volumetric energy density of the LCO cathode can reach 885.9 Wh kg⁻¹ and 3721 Wh L^{-1,} respectively. Matched with the graphite anode, the projected energy density of the assembled graphite||LCO full cells was estimated to be 303 Wh Kg⁻¹, with the corresponding parameters summarized in FIG. 37. These results highlight the high application potential of the designed electrolyte in practical LIBs.

### Example 4

### Properties of Different CEI

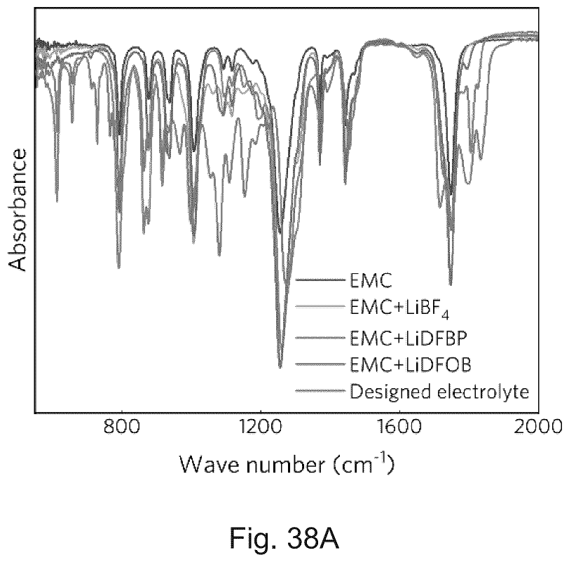

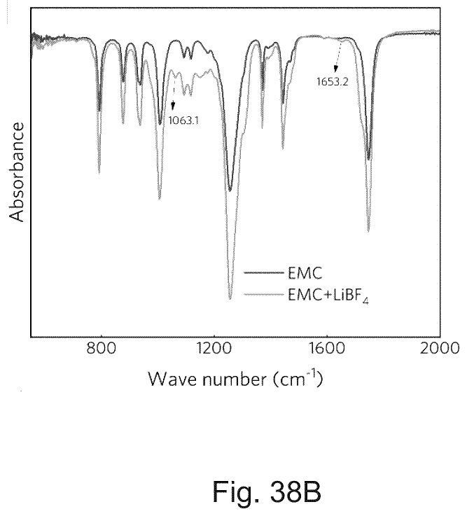

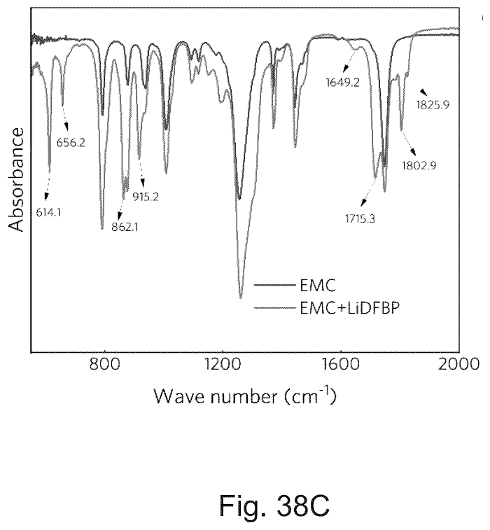

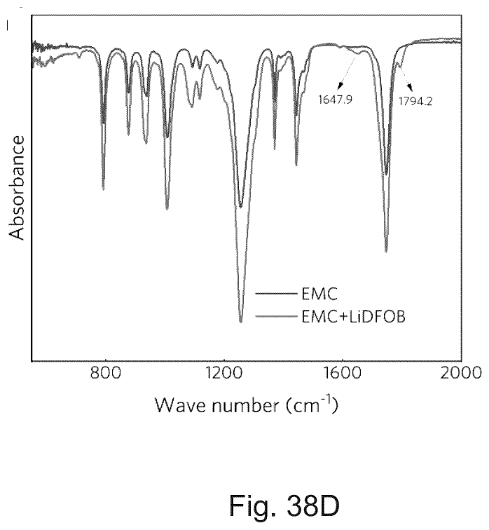

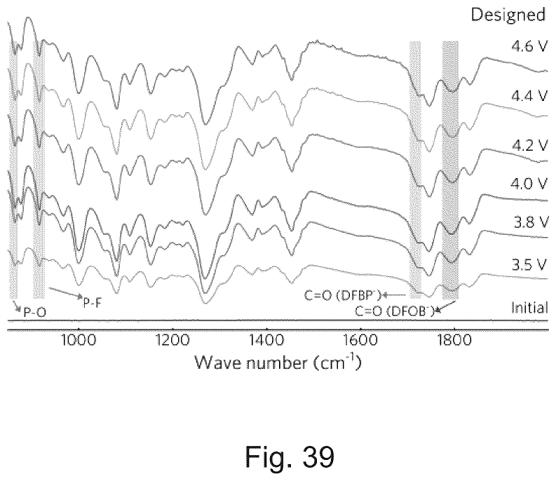

It is believed that the excellent cycling stability of the LCO cathode under high voltages is attributed to the anion-induced CEI. To confirm this, in-situ Fourier transform infrared spectrometer (FTIR) was conducted. FIGS. 38A to 38D shows the ex-situ FTIR spectra of pure EMC, EMC solutions with different lithium salts and the designed electrolyte. Specifically, the characteristic peak of LiBF₄ is observed at 1063.1 cm⁻¹, corresponding to the B—F stretching vibration mode, while LiDFOB's characteristic peak is found at 1794.2 cm⁻¹, assigned to the C═O stretching vibration. For LiDFBP, more characteristic peaks appear, which are located at around 862.1, 915.2, and 1715.3 cm⁻¹, representing P—F, P—O and C═O stretching vibrations, respectively. When charged to 3.5 V (vs. Li/Li⁺), five characteristic peaks of oxidation appeared, corresponding to the decomposition of P-O bonds (863.9 cm⁻¹), P—F bonds (915.5 cm⁻¹), and the C═O bond of DFOB⁻(1793.5 cm⁻¹) as well as DFBP⁻(1716.3 cm⁻¹), indicating the oxidation of DFOB⁻and DFBP⁻to form CEI (FIG. 39). The slight difference in the characteristic peak of certain lithium salts in the EMC solution and the designed electrolyte is attributed to the interaction between components in the electrolyte. In particular, the characteristic peak of BF₄⁻ oxidation did not appear even when charged to 4.6 V (vs. Li/Li⁺), indicating that it is difficult for BF₄⁻ to participate in the formation of CEI in the designed electrolyte.

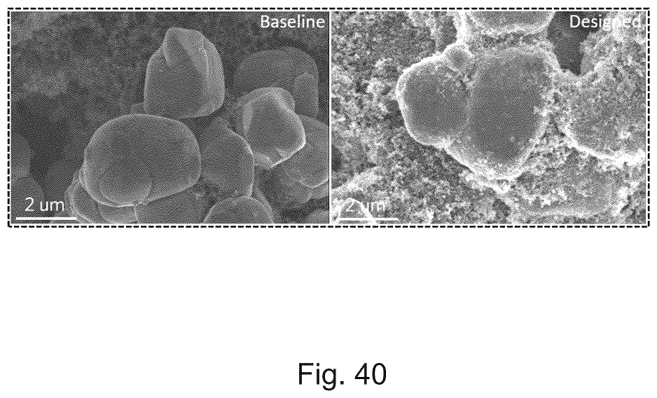

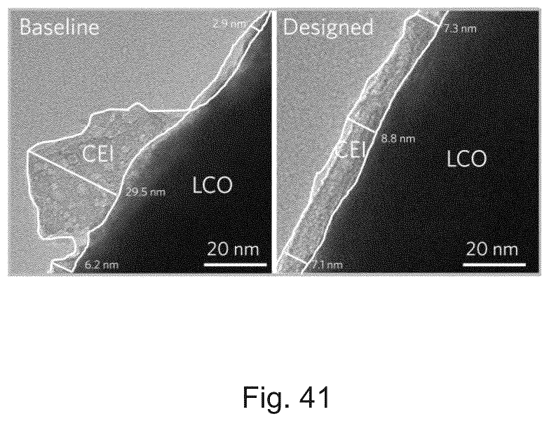

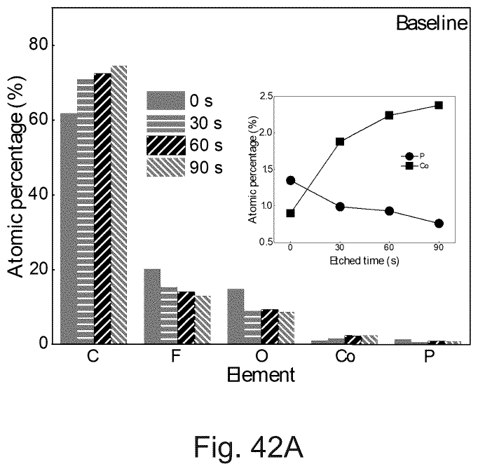

To analyze the morphology and composition of anion-induced CEI, scanning electron microscope (SEM), high-resolution transmission electron microscope (HR-TEM) and X-ray photoelectron spectroscopy (XPS) were carried out. Due to the enhanced CEI formation ability, the designed electrolyte manifests efficient construction of a protective interphase on the LCO surface after the first two activation cycles, as shown in the SEM images (FIG. 40). More specifically, the TEM patterns demonstrate the dense and uniform morphology of the CEI induced by the designed electrolyte with a thickness of approximately 7-8 nm (FIG. 41). In sharp contrast, an uneven CEI is observed on the surface of LCO cycled in baseline electrolyte, with the thickness ranging from several nanometers to approximately 30 nm.

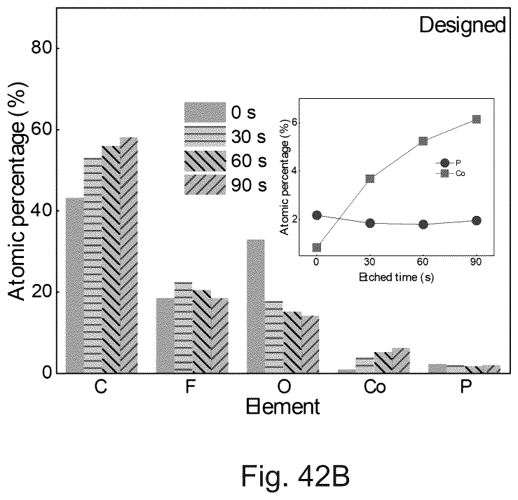

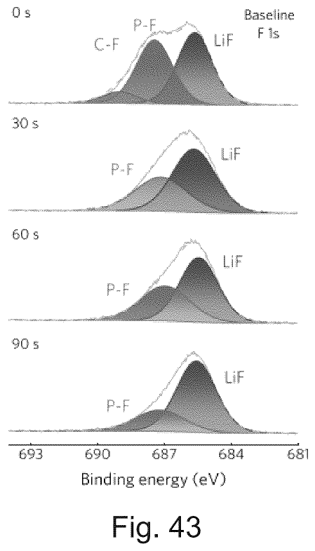

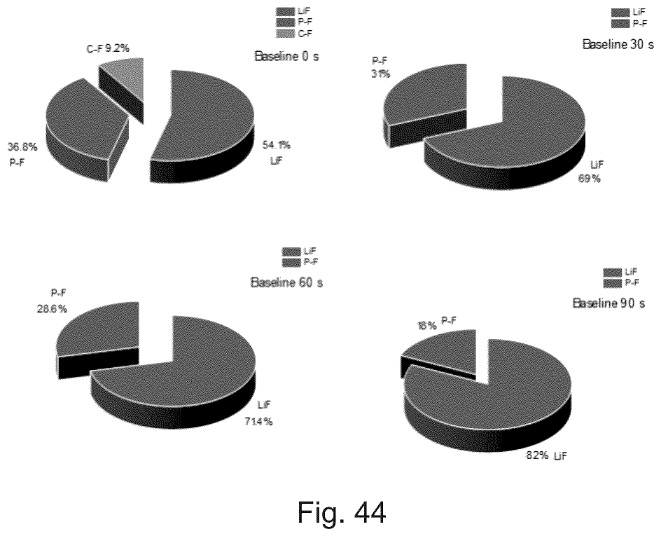

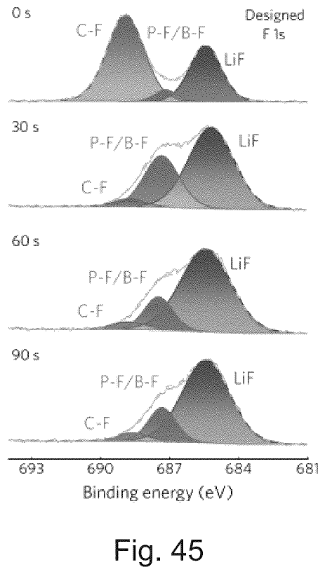

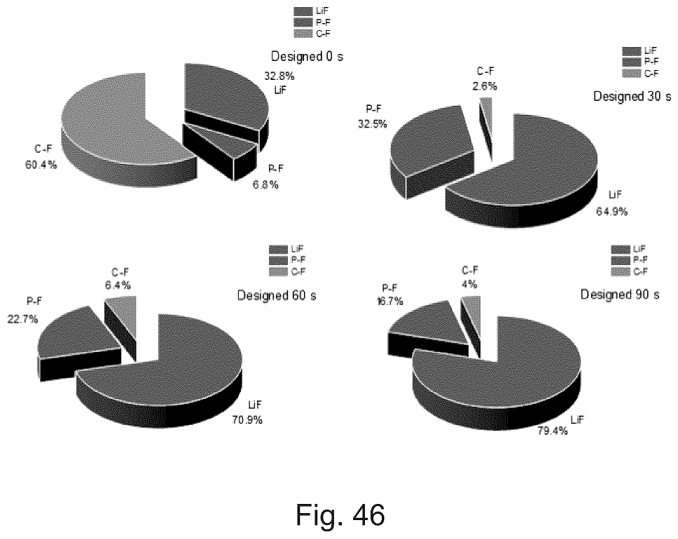

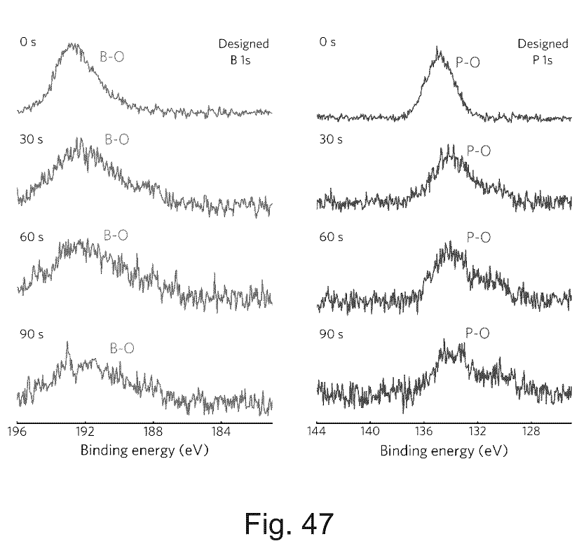

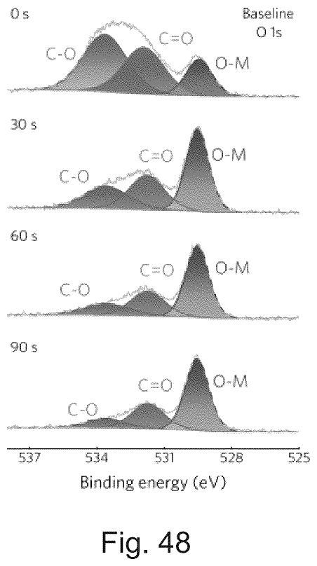

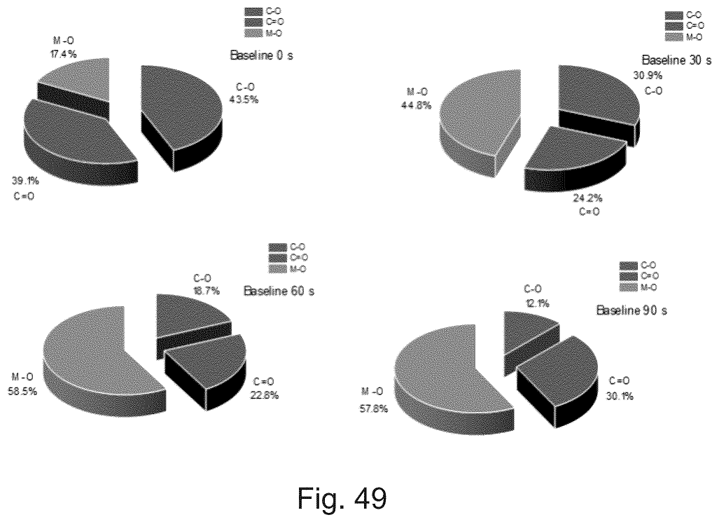

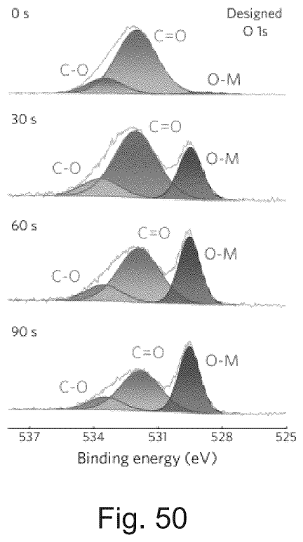

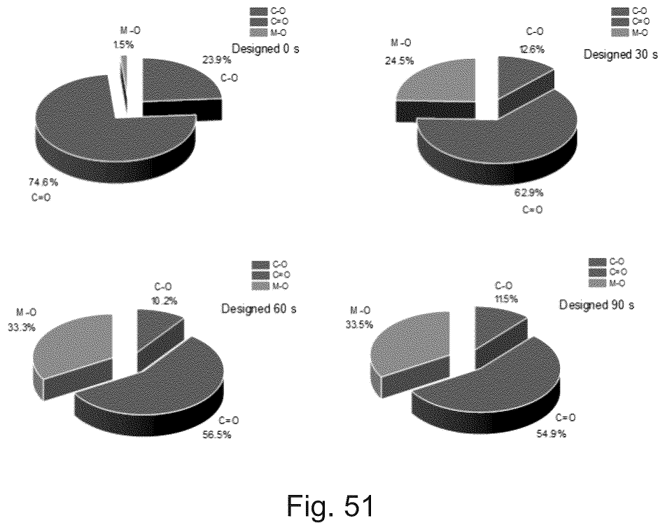

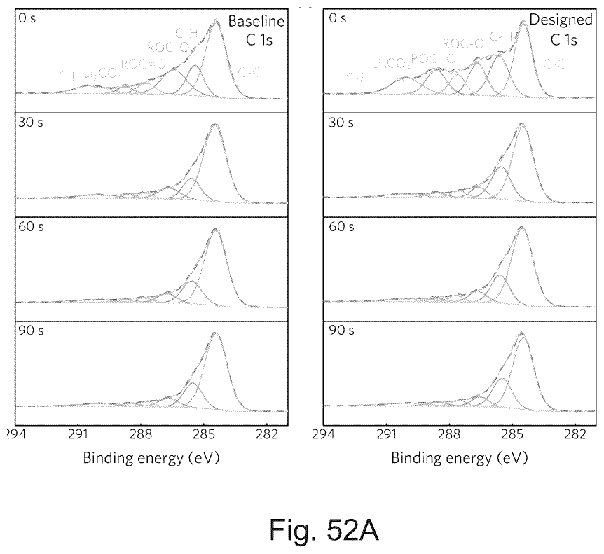

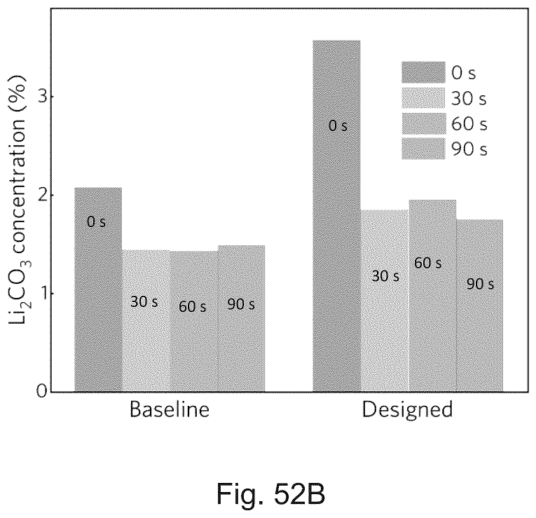

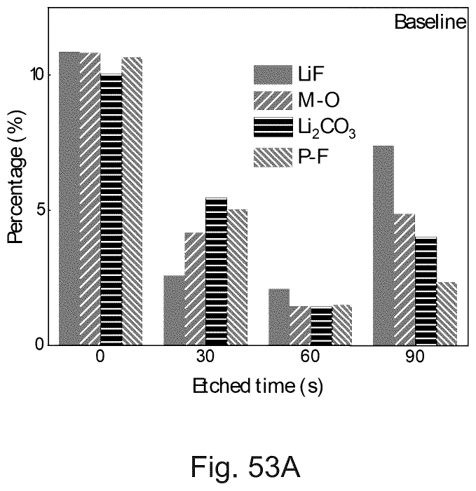

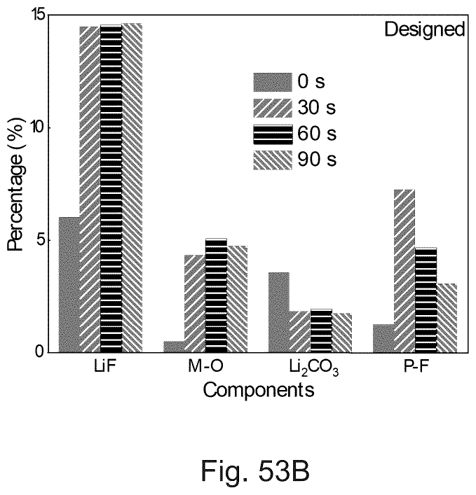

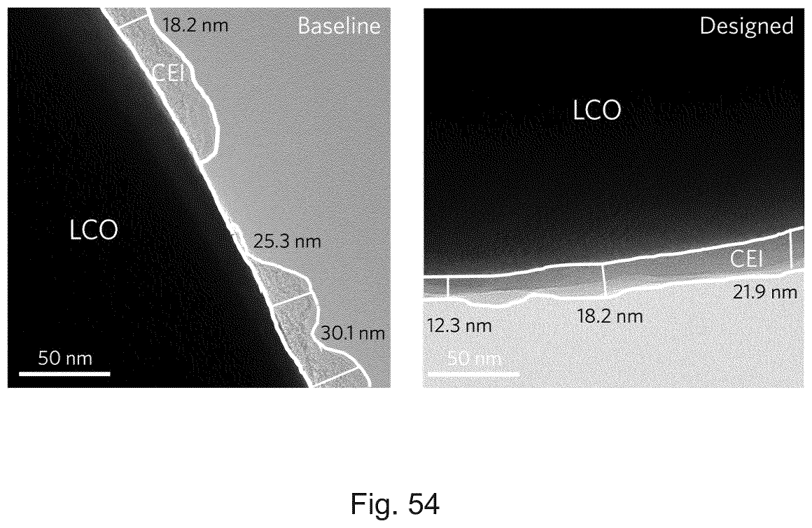

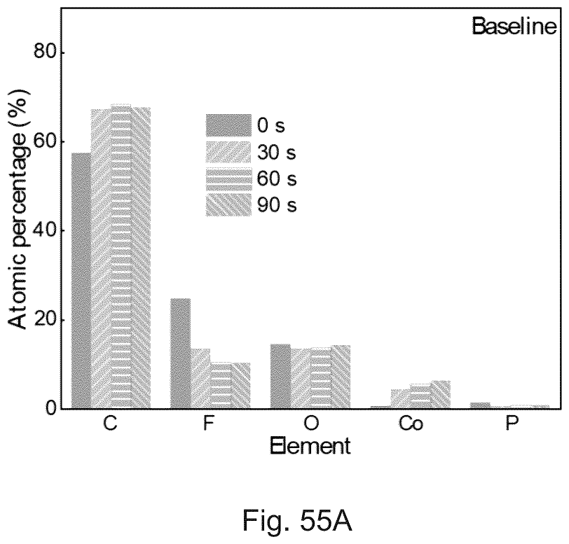

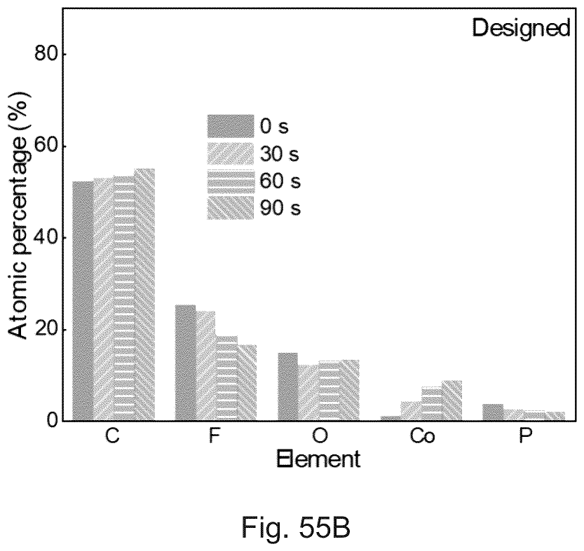

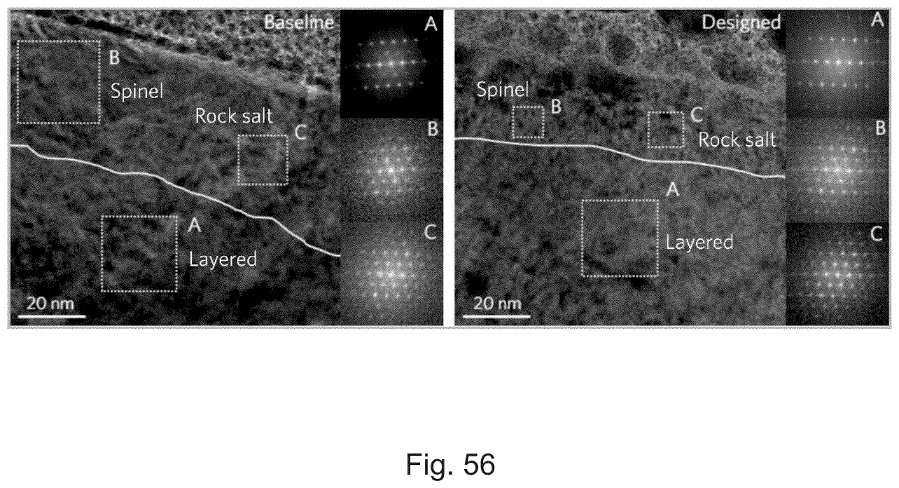

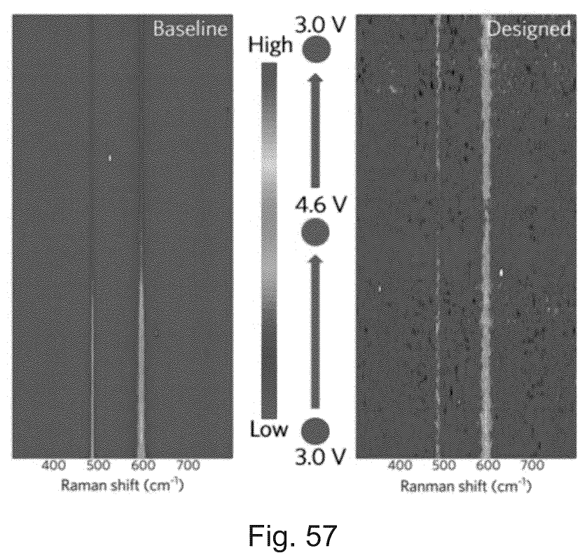

XPS data reveal the composition of the CEI formed by different electrolytes. It is believed that LiF may have high chemical inertness that is considered essential in suppressing the interfacial degradation of layered cathodes during high-voltage operations. Due to the oxidative decomposition of anions, the CEI formed by the designed electrolyte is richer in F elements (FIGS. 42A and 42B). In addition, the proportion of LiF (located at 685.5 eV) in the CEI formed by the baseline electrolyte decreases with the increase of etching time (FIGS. 43 and 44), while a larger proportion of LiF generated by the designed electrolyte is distributed in the inner layer of CEI (FIGS. 45 and 46), which benefits from the preferential oxidation of the anions. More LiF in the inner CEI, which is closer to the LCO surface, makes it more effective in suppressing the irreversible LCO interfacial phase transition. The higher proportion of C-F bonds on the surface of LCO cathode cycled in designed electrolyte is mainly attributed to the partial exposure of the polyvinylidene difluoride (PVDF) binder caused by the thinner CEI, which can also be supported by the gradient of high atomic percentages for Co element on the LCO surface (FIGS. 42A and 42B).

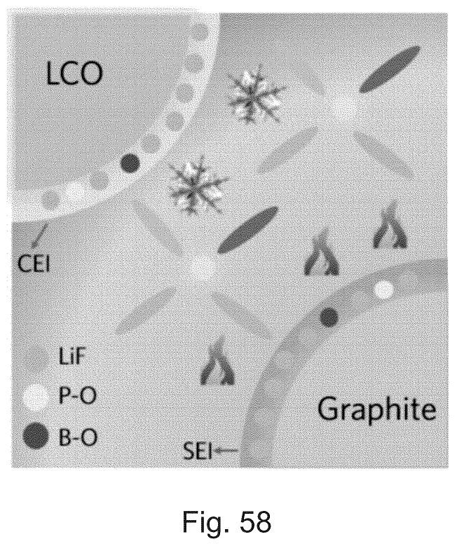

Moreover, the P—O and B—O species generated by the designed electrolyte further enhance the CEI stability, inhibiting the continuous electrolyte decomposition, especially under high temperatures (FIG. 47). The O1s XPS spectra also demonstrate the dense nature of CEI formed by the designed electrolyte. The O-M species (~529.5 eV) is considered as the Co—O bonds, mainly contributed by the LCO particle. While on the surface without etching, the observed O-M species may partially arise from dissolved Co ions. Therefore, the relatively higher proportion of O-M species on the LCO surface cycled in baseline electrolyte indicates that the formed CEI cannot effectively inhibit the dissolution of Co ions (FIGS. 48 and 49). Notably, the relatively higher content of C═O bonds observed on the LCO surface cycled in the designed electrolyte may stem from the higher proportion of lithium carbonate (Li₂CO₃) in the induced CEI (FIGS. 50 and 51), which can be verified by the C 1s XPS spectra (FIGS. 52A and 52B). FIGS. 53A and 53B show the specific concentration gradient of certain components in different CEI layers. With increasing etching depth, the concentration of inorganic components in CEI induced by the designed electrolyte is higher than that induced by the baseline electrolyte, including LiF, Li₂CO₃ and P—F species, revealing the ability to form the inorganic-rich CEI of the designed electrolyte. These findings reinforce the superior interfacial stability offered by the designed electrolyte under high-voltage operation.

### Example 5

### Stability of CEI and Protection on the Interfacial Phase of LCO

To reveal the stability of different CEI, HR-TEM and XPS were conducted after 200 cycles. As shown in FIG. 54, after prolonged cycling, the thickness of CEI induced by the designed electrolyte increases to approximately 10-20 nm while maintaining a dense and uniform morphology. However, the CEI on the LCO surface formed in the baseline electrolyte exhibits significant structural degradation, with visible breakdowns and partial exposure of the underlying LCO particles. This phenomenon is attributed to the fact that the higher mechanical strength of the anion-induced CEI with more inorganic components enhances its stability during the long-term cycling process. Moreover, the CEI induced by the designed electrolyte exhibits more F element and less C element, retaining its composition features (FIGS. 55A and 55B), while there is more Co element on the LCO surface after cycling in the baseline electrolyte, demonstrating the partial CEI cracks as shown in TEM patterns in FIG. 54. These results demonstrate the high stability, morphologically and chemically, of the protective interphase formed by the designed electrolyte on the LCO surface.

The protective role of the designed electrolyte on the LCO interfacial phase under high voltages was investigated using HR-TEM and in-situ Raman. Firstly, the HR-TEM images and corresponding fast Fourier transform (FFT) patterns of cycled LCO particles confirm the protective role of the designed electrolyte on the LCO interfacial structure (FIG. 56). After 200 cycles in the baseline electrolyte, regions exhibiting spinel and rock salt phases with a thickness of approximately 40 nm are observed on the LCO surface. Conversely, the LCO particles cycled in the designed electrolyte predominantly retain the layered structure, confirming that anion-induced CEI can effectively inhibit the interfacial structure degradation of LCO under high voltage.

In-situ Raman was used to monitor the structural evolution of the LCO interfacial phase during cycling (FIG. 57). At the onset of charging, two characteristic peaks (485 and 595 cm⁻¹, O—Co—O bending (E_{g}) and Co—O stretching (A_{1g})) appear for LCO in both electrolytes, indicating the layered phase. These peaks disappear when the charging voltage reaches 4.6 V (vs. Li/Li⁺), indicating the phase transition of LCO from the layered phase to the spinel phase at high voltage. However, when discharged to 3.0 V (vs. Li/Li⁺), the characteristic peaks of the layered phase fail to reappear for cycled LCO in the baseline electrolyte, whereas cycled LCO in the designed electrolyte fully reverts to the layered phase. This reconfirms the enhanced effect of the designed electrolyte in promoting the reversible phase transition of LCO at high voltages.

By combining high-temperature stability and enhanced ionic conductivity under low temperatures, the designed electrolyte enables robust high-voltage operation across a wide temperature range (FIG. 58). Specifically, the alleviated side-reaction, including continuous decomposition of electrolyte, irreversible interfacial phase transition of LCO, the thermal decomposition of electrolyte, and inevitable CEI evolution, endows the LCO cathodes with significantly enhanced cycling stability under high cutoff voltage and elevated temperatures. These improvements are contributed by the anion-induced dense protective interphase with high chemical inertness and uniform morphology, as well as the inherent antioxidant property and thermal stability of the designed electrolyte. Moreover, the low over-potential imparted by the designed electrolyte and its inherent high ionic conductivity at low temperatures enable the battery to exhibit considerable capacity at extremely low temperatures. This demonstrates the great potential of cation-anion solvation engineering in designing advanced electrolytes capable of delivering stable and reliable performance under harsh conditions.

The invention has been given by way of example only, and various other modifications of and/or alterations to the described embodiment may be made by persons skilled in the art without departing from the scope of the invention as specified in the appended claims.

1. An electrolyte for lithium-based battery comprising at least three lithium salts and a carbonate solvent mixture, wherein the at least three lithium salts are selected from the group consisting of lithium tetrafluoroborate (LiBF₄), lithium difluorooxalate borate (LiDFOB), lithium difluorodioxalate phosphate (LiDFBP), lithium bisfluorosulfonimide (LiFSI) and lithium bis((trifluoromethyl)sulfonyl)azanide (LiTFSI).

2. The electrolyte as claimed in claim 1, wherein the at least three lithium salts include lithium tetrafluoroborate (LiBF₄), lithium difluorooxalate borate (LiDFOB), and lithium difluorodioxalate phosphate (LiDFBP).

3. The electrolyte as claimed in claim 2, wherein the lithium tetrafluoroborate (LiBF₄), lithium difluorooxalate borate (LiDFOB), lithium difluorodioxalate phosphate (LiDFBP) have a molar ratio of about 4:4:3.

4. The electrolyte as claimed in claim 1, wherein the at least three lithium salts have a total concentration from about 0.5 M to about 1.5 M.

5. The electrolyte as claimed in claim 4, wherein the at least three lithium salts have a total concentration of about 1.1 M.

6. The electrolyte as claimed in claim 1, wherein the carbonate solvent mixture includes propylene carbonate (PC), ethyl methyl carbonate (EMC), dimethyl carbonate (DMC), and fluoroethylene carbonate (FEC).

7. The electrolyte as claimed in claim 6, wherein the propylene carbonate (PC), ethyl methyl carbonate (EMC), dimethyl carbonate (DMC), and fluoroethylene carbonate (FEC) have a volume ratio of a:b:c:d, where a is about 2-5, b is about 3-5, c is about 1-3, d is about 1-2, with a+b+c+d=1.

8. The electrolyte as claimed in claim 1 further comprising an additive selected from the group consisting of vinylene carbonate (VC), 1,3-propanesultone (PS), difluorocarbonated ethylene carbonate (DFEC), tri-(tri-methyl-silane) borate (TMSB), methylene methanedisulfonate (MMDS), and tri-(tri-methyl-silane) phosphate (TMSP), and a combination thereof.

9. The electrolyte as claimed in claim 8, wherein mass of the additive is 5% or less of the total mass of the electrolyte.

10. The electrolyte as claimed in claim 1, wherein decomposition voltage of the electrolyte is about 4.43 V (vs. Li/Li⁺) under a measurement of linear sweep voltammetry (LSV) with a cutoff current density of about 4 μA cm⁻².

11. The electrolyte as claimed in claim 1 maintains liquid form under a temperature from about- 80 °C to about 45 °C

12. The electrolyte as claimed in claim 1 is stable below or at about 80 °C for at least 140 hours.

13. A lithium-based battery comprising:
a cathode comprising a cathode active material selected from the group consisting of lithium cobalt oxide (LCO), lithium iron phosphate (LFP), lithium manganate (LMO), lithium iron phosphate with manganese added (LMFP), nickel-rich NCM, nickel-rich NCA, and graphite;
an anode; and
an electrolyte comprising at least three lithium salts selected from lithium tetrafluoroborate (LiBF₄), lithium difluorooxalate borate (LiDFOB), and lithium difluorodioxalate phosphate (LiDFBP), and a carbonate solvent mixture selected from the group consisting of propylene carbonate (PC), ethyl methyl carbonate (EMC), dimethyl carbonate (DMC), and fluoroethylene carbonate (FEC).

14. The lithium-based battery as claimed in claim 13, wherein the cathode comprises a cathode active material of LCO and the anode comprises an anode active material selected from the group consisting of graphite, silicon, lithium metal, silicon-carbon composite, and silicon dioxide.

15. The lithium-based battery as claimed in claim 13, wherein the cathode comprises a cathode active material of graphite and the anode has an anode active material selected from the group consisting of lithium metal, silicon, silicon-carbon composite, and silicon dioxide.

16. The lithium-based battery as claimed in claim 13, wherein the cathode has a mass loading of about 6.6 mg cm⁻².

17. The lithium-based battery as claimed in claim 13, wherein the anode has a mass loading of about 2.0 mg cm⁻² to about 4.0 mg cm⁻².

18. The lithium-based battery as claimed in claim 13, wherein the lithium-based battery has an average Coulombic efficiency of at least 99% when operated at a voltage of at least 4.6 V under a temperature of about 45 °C

19. The lithium-based battery as claimed in claim 13, wherein the electrolyte is arranged to form a cathode-electrolyte interphase (CEI) on the cathode at a voltage of about 4.6V for stabilizing interfacial phase of said cathode under said high voltage.

20. The lithium-based battery as claimed in claimed 19, wherein the cathode-electrolyte interphase is uniformly disposed on the cathode surface and has a thickness from about 7 nm to about 20 nm.

21. The lithium-based battery as claimed in claim 20, wherein the cathode-electrolyte interphase comprises LiF in a concentration gradient such that the LiF concentration is higher at a side proximal to the cathode surface than at a side distal from the cathode surface.
